(19) United States
(12) Patent Application Publication
(10) Pub. No.: US 2012/0319487 A1
(43) Pub. Date: Dec. 20, 2012

(54) Integrated Battery Backup and Charging for Mobile Devices

(76) Inventor: Rakesh Shah, Murrieta, CA (US)

(21) Appl. No.: 13/526,439

(22) Filed: Jun. 18, 2012

Related U.S. Application Data
(60) Provisional application No. 61/497,624, filed on Jun. 16, 2011.

(51) Int. Cl. H02J 7/00; H02J 7/02

(52) U.S. Cl. 307/66; 320/111

(57) ABSTRACT

A battery backup and charging device (BBCD) is described. The BBCD includes a battery, a charger coupled to the battery, AC prongs coupled to the charger, and a connection module adapted to connect the battery and charger to the mobile device. The charger may provide charging to the battery and an internal battery of the mobile device in parallel. The BBCD and mobile device may be enclosed in a single housing. The charger may include a planar transformer.

### CROSS-REFERENCE TO RELATED APPLICATIONS

This application claims priority to U.S. Provisional Patent Application having Ser. No. 61/497,624, filed on Jun. 16, 2011.

### BACKGROUND

Mobile device use is ubiquitous. Many users may want to utilize a mobile device (e.g., a cellular phone, a tablet device, a notebook computer, etc.) to provide various functions (e.g., telephonic communications, text-based communication, Internet browsing, gaming, location services, etc.). Many of these functions may affect the available battery life of the mobile device. Use of the various functions may cause a rechargeable battery of the mobile device to discharge and require charging from an external source to facilitate further use of the mobile device.

Many users may not have access to such an external source at any given time. Thus the users may be inconvenienced by having to relocate to an area where an external source is accessible, and/or discontinue use of various functions provided by the mobile device. The users may also have to locate (or carry) a cable and/or power converter to connect the device to the external source.

In addition, users may be inclined to use devices that have a slim profile. Thus, such users may not want to add a bulky external battery to a mobile device in order to increase the usability of the device.

Moreover, many users may travel with multiple mobile devices (e.g., a cellular phone, a tablet device, and a notebook computer) that each require a separate power converter and/or connection cable in order to charge each device.

Therefore, there exists a need for a flexible, compact, integrated backup battery and charging solution.

### BRIEF SUMMARY

Broadly, some embodiments of the present invention generally provide a way to provide backup power and charging capability to mobile devices (e.g., cellular/mobile phones, laptops, notebooks, personal digital assistants, tablets, other battery operated devices, etc.). A device according to some embodiments of the present invention may empower users to keep their mobile devices charged without carrying any cables because the device is able to be constantly connected to the mobile device, and the user may not need to carry a separate charger and/or backup battery. Some embodiments of the device may be housed in a casing that may include a battery, a planar transformer, and/or AC prongs that facilitate easy charging and re-charging of the electronic device and backup battery without the use of external cords, while maintaining a slim profile and light weight.

The device of some embodiments may include a very thin main charger, which may be able to convert an AC source voltage to a DC output voltage. This output voltage may then be applied to, for instance, an internal battery, a backup battery, an external device, etc. A smart charging circuit within the system may allow all connected components to charge in a certain sequence (not necessarily in parallel) such that battery life is extended along with rapid charging and/or supplying power.

In addition to, or in place of, AC or backup battery charging, the device may also provide solar cell charging. In some embodiments, the solar cells may be built into the housing of the device. This may allow a user to charge a mobile device if the user is not able to access an AC source. The output of the solar cell may be connected thorough a blocking diode to the output of the main charger. Some embodiments of the device may also have USB charging capability, as well as a USB output which may be able to provide current to charge another external device that is able to use a USB connection as a power input. Some embodiments may also allow USB communication to and/or from a set of external devices. Such a USB feature may allow the device of some embodiments to connect to multiple types of devices across multiple platforms. All such options may be provided in a single package or housing.

In some embodiments, the various functions of the device may be controlled by a user. For example, a user may be able to select and/or program preferred charging schemes (e.g., charge internal battery with a high priority, charge external battery with a high priority, charge external device battery with a high priority, etc.) based on various threshold, preset, programmed, default, and/or otherwise determined or calculated conditions. Such control may be provided using various appropriate interfaces. In addition, a user may be able to select various operation modes (e.g., standby, charging, etc.) in various appropriate ways.

Different embodiments may include various different features. For instance, some embodiments may include circuitry to boost battery voltage. As another example, some embodiments may include status indicators (e.g., a set of LEDs). Some embodiments may facilitate fast charging. Some embodiments may provide a stand and/or protection for the mobile device, including protection of front glass. A retractable charging cable and/or retractable headset may be provided in some embodiments. In addition, some embodiments may include a surface that has materials able to provide a reliable grip to a user.

An exemplary embodiment of the present invention may provide a housing for a mobile device. The housing may include a battery, a charger coupled to the battery, AC prongs coupled to the charger, and a connection module adapted to connect the battery and charger to the mobile device.

Another exemplary embodiment of the present invention may provide a system adapted to provide charging and backup battery power. The system may include an AC power source, a backup battery and charging device (BBCD) coupled to the AC power source. The BBCD may include a backup battery, a charger coupled to the backup battery, and AC prongs coupled to the charger, the AC prongs adapted to couple to the AC power source. The system may also include a mobile device coupled to the BBCD, the mobile device comprising a battery.

Yet another exemplary embodiment of the present invention may provide a mobile device with an embedded battery backup and charging device (BBCD). The mobile device may include a primary battery, a backup battery coupled to the primary battery, a charger coupled to the battery, and AC prongs coupled to the charger.

The preceding Summary is intended to serve as a brief introduction to some embodiments of the invention. It is not meant to be an introduction or overview of all inventive subject matter disclosed in this document. The Detailed Description that follows and the Drawings (or “Figures” or “FIGs.”) that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matter is not to be limited by the illustrative details in the Summary, Detailed Description and the Drawings, but rather is to be defined by the appended claims, because the claimed subject matter may be embodied in other specific forms without departing from the spirit of the invention.

### BRIEF DESCRIPTION OF THE DRAWINGS

The novel features of the invention are set forth in the appended claims. However, for purpose of explanation, several embodiments of the invention are set forth in the following drawings.

FIG. 1 illustrates a schematic block diagram of a battery backup and charging system provided by some embodiments;

FIG. 2 illustrates a flow chart of a conceptual process used by some embodiments to define an operating scheme used by the battery backup and charging system of FIG. 14;

FIG. 3 illustrates a connection between an external device and a BBCD that may be used to charge the internal battery of the external device;

FIG. 4 illustrates an external secondary charging mechanism electronically connected to the BBCD;

FIG. 5 illustrates an external secondary charging mechanism and an external device coupled to the BBCD;

FIG. 6 illustrates the BBCD connected to an external device and a computing device;

FIG. 7 illustrates a schematic block diagram of an exemplary embodiment of a BBCD adapted to be used with a mobile device;

FIG. 8 illustrates a schematic block diagram of an exemplary embodiment of an alternative BBCD adapted to be used with a mobile device;

FIG. 9 illustrates a schematic block diagram of an exemplary embodiment of another alternative BBCD adapted to be used with a computing device;

FIG. 10 illustrates a flow chart of a conceptual process used by some embodiments to define a charging scheme;

FIG. 11 illustrates a flow chart of a conceptual process used by some embodiments to optimize usage of available charging capability;

FIG. 12 illustrates a flow chart of a conceptual process used by some embodiments to initiate a boost feature;

FIG. 13 illustrates a flow chart of a conceptual process used by some embodiments to display the status of the BBCD to a user;

FIG. 14 illustrates first and second perspective views of one embodiment of a mobile device encased in a housing that includes a BBCD;

FIG. 15 illustrates a rear view and perspective view of the BBCD housing of FIG. 14;

FIG. 16 illustrates first and second perspective views of a BBCD housing of some embodiments, showing a way the BBCD housing may be secured to a mobile device for us;

FIG. 17 illustrates a first and second perspective section view of a BBCD housing of some embodiments, highlighting the slim profile of the BBCD;

FIG. 18 illustrates an exploded view of the BBCD housing of FIG. 14;

FIG. 19 illustrates various views of a BBCD housing of some embodiments;

FIG. 20 illustrates an exploded view of the BBCD housing of FIG. 19;

FIG. 21 illustrates various views of the rear face of some embodiments of the housing of FIG. 19;

FIG. 22 illustrates various views of the rear retaining plate of some embodiments of the housing of FIG. 19;

FIG. 23 illustrates various views of the front face of some embodiments of the housing of FIG. 19;

FIG. 24 illustrates various views of the retaining element of some embodiments of the housing of FIG. 19;

FIG. 25 illustrates various views of the side cover of some embodiments of the housing of FIG. 19;

FIG. 26 illustrates various views of the top cover of some embodiments of the housing of FIG. 19;

FIG. 27 illustrates various views of a set of lenses and caps that may be included in some embodiments of the housing of FIG. 19;

FIG. 28 illustrates various views of an alternative BBCD housing of some embodiments;

FIG. 29 illustrates an exploded view of the alternative BBCD housing of FIG. 28;

FIG. 30 illustrates several views of a removable charger of some embodiments;

FIG. 31 illustrates several views of a housing including a removable charger of some embodiments;

FIG. 32 illustrates various views of an alternative, charger-only, housing of some embodiments;

FIG. 33 illustrates two perspective views of an exemplary embodiment of a BBCD for a computing device;

FIG. 34 illustrates one embodiment of a retractable AC plug that may be included in the BBCD of FIG. 33;

FIG. 35 illustrates the retractable AC plug of FIG. 34 wound up and retracted into the housing of the BBCD of FIG. 33;

FIG. 36 illustrates the BBCD of FIG. 33 removed from the notebook computer;

FIG. 37 illustrates a bottom view of the BBCD of FIG. 33;

FIG. 38 illustrates several views of a BBCD housing that may be adapted to be used with various computing devices;

FIG. 39 illustrates a schematic block diagram of an embedded BBCD of some embodiments;

FIG. 40 illustrates a conceptual schematic block diagram of a BBCD of some embodiments; and

FIG. 41 illustrates a schematic block diagram of a conceptual computer system with which some embodiments of the invention may be implemented.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Several more detailed embodiments of the invention are described in the sections below. Section I provides a conceptual description of a system provided by some embodiments. In addition, Section II describes a battery backup and charging device (BBCD) provided by some embodiments. Section III then describes the operation of the BBCD during operation in some embodiments. Next, Section IV describes various example housings that store and protect the BBCD of some embodiments. Section V then describes various embedded solutions provided by some embodiments. Next, Section VI describes implementation of various applications using the system of some embodiments. Lastly, Section VII describes a computer system which implements some of the embodiments of the invention.

### I. System

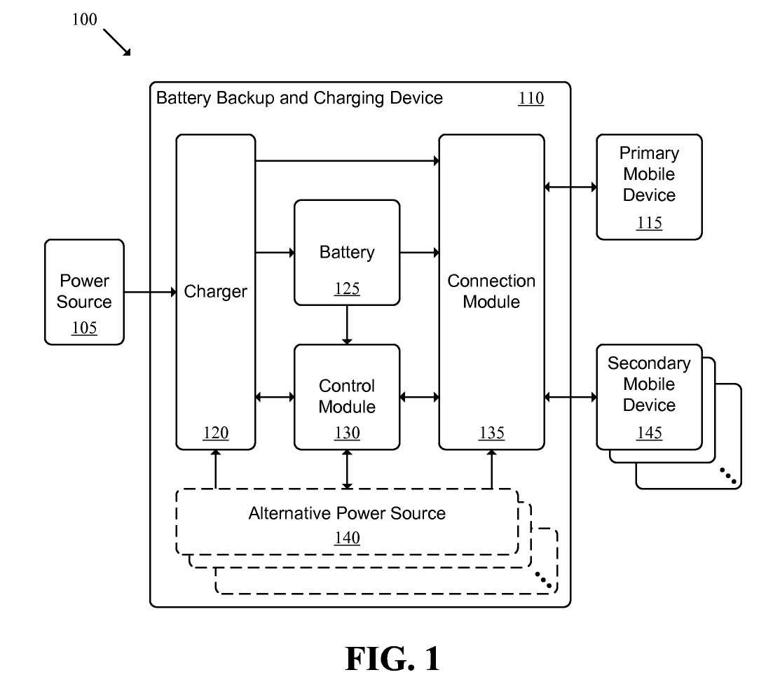

FIG. 1 illustrates a schematic block diagram of a battery backup and charging system 100 provided by some embodiments. Specifically, this figure shows the various components, connections, and communication pathways that may be included in the system. As shown, system 100 includes a power source 105, a BBCD 110, and a mobile device 115.

The power source 105 may be any source capable of providing power (e.g., an electrical outlet, a battery, a solar cell, etc.). The BBCD 110 may be adapted to receive power from one or more power sources, store received power, and/or provide power to one or more mobile devices. The mobile device 115 may be any device that requires power (e.g., a cellular device, a Smartphone, a tablet device, a notebook computer, a digital camera, etc.).

As shown, the BBCD 110 may include a charger 120, a battery 125, a control module 130, a connection module 135, and one or more alternative power sources 140. The charger 120 may be adapted to receive power from the power source 105 and convert the power into a format that is able to be provided to the battery 125 or mobile device 115. The battery 125 may include one or more components that are adapted to store and/or provide power. The control module 130 may be adapted to send and/or receive communications and/or instructions to/from one or more other system components. The connection module 135 may be adapted to allow the charger 120, battery 125, alternative power source(s) 140, and/or other components included in the BBCD 110 to connect to one or more mobile devices 115 and/or secondary mobile devices 145. The alternative power source 140 may be adapted to provide power to the BBCD 110. For instance, the alternative power source 140 may include a solar cell, a kinetic energy converter, and/or other appropriate components. In some embodiments, one or more of the alternative power source(s) may include an output that may be connected in parallel with the output of the charger 120.

During operation, the BBCD 110 may be connected to a mobile device 115 through the connection module 135. In addition, the BBCD 110 may be connected to an external power source 105. The BBCD 110 may receive power from the external power source 105 (or other appropriate source such as an alternative power source 140). The received power may be provided to the charger 120. The charger may convert the power into a format that is compatible with the battery 125 and/or that may be provided to the mobile device 115 through the connection module 135.

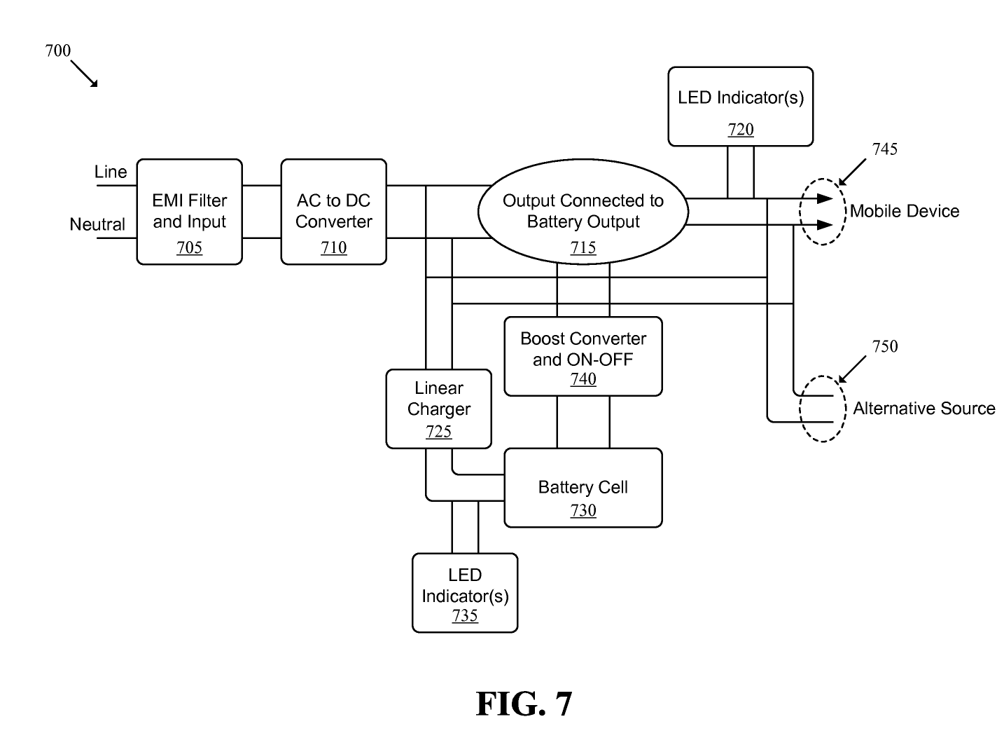

The control module 130 may monitor the output of the charger 120, the charge level of the battery 125, the charge level of an internal battery of the mobile device 115, and/or the output of any alternative power sources 140 that may be available. In addition, the control module 130 may control the operation of the connection module 135 such that the appropriate resource may be provided to the mobile device 115. For instance, if the BBCD 110 is connected to an external power source, the control module 130 may provide the output of the charger 120 to the battery 125 and/or to the mobile device 115 (through the connection module 140) such that the battery 125 and/or internal battery of the mobile device 115 may be able to receive and/or store power, as appropriate. Various charging schemes and algorithms will be discussed in more detail in reference to FIGS. 7-13 below.

In addition, some embodiments may allow one or more secondary mobile devices 145 (e.g., a cellular phone, a digital camera, an mp3 player, a notebook computer, a tablet device, etc.) to be connected to the BBCD 110. In this way, multiple devices, internal and/or external, may be charged by the battery backup and charging device 110. Some embodiments may also be able to receive power from a secondary mobile device 145 and use the provided power to charge a battery in the primary mobile device 115, or the battery 125 included in the BBCD 110.

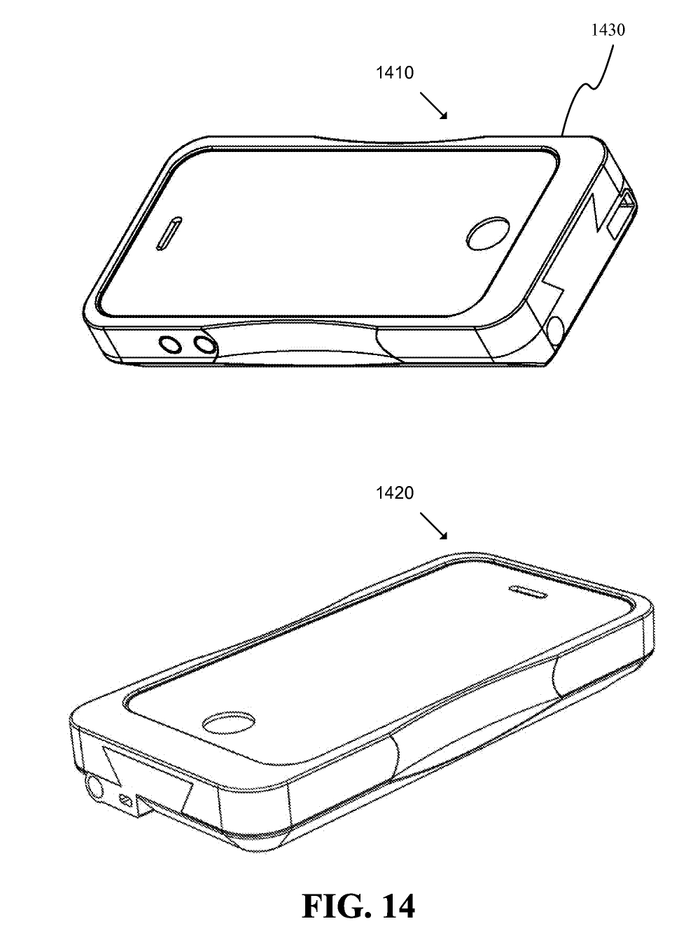

In some embodiments the BBCD 110 may be embedded in a housing adapted to store and/or protect the mobile device 115. Examples of such housings will be described in reference to FIGS. 14-38 below. Various specific materials, electronic components, software components, etc. will be described in more detail in reference to the specific examples that will be provided below.

One of ordinary skill in the art will recognize that the system 100 may be implemented in various different ways without departing from the spirit of the invention. In addition, one of ordinary skill will recognize that FIG. 1 is a conceptual representation of the system and an actual implementation may include various other components, connections, communication pathways, etc. Furthermore, various individual components may be combined to form single components (e.g., the control module 130 and connection module 135 may be combined to form a single control/connection module) and/or various individual components may be broken into a number of sub-components (e.g., the control module may be divided into a communication module and a processing module). The system of some embodiments may also include other components that are not shown in FIG. 1 (e.g., a memory storage element may be used to store instructions and/or data that may be provided to the control module 130).

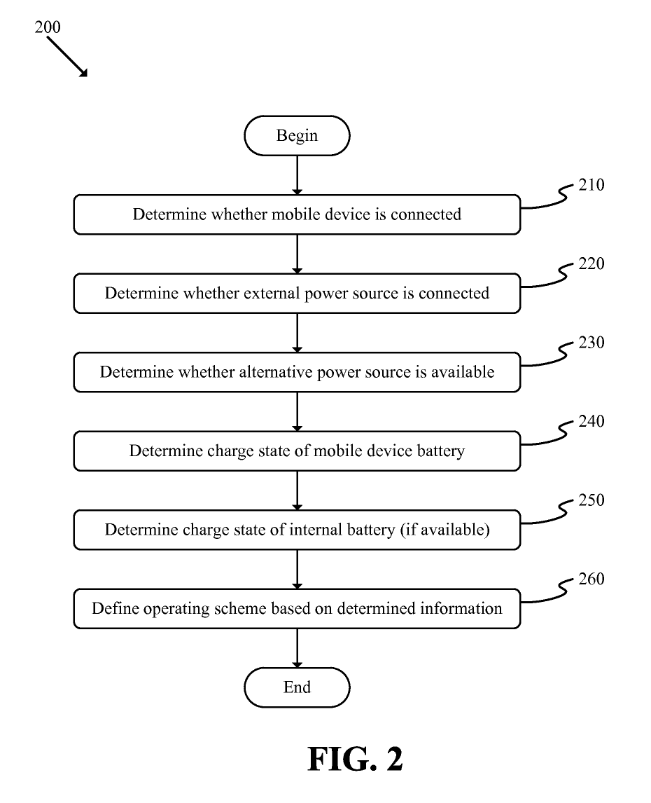

FIG. 2 illustrates a flow chart of a conceptual process 200 used by some embodiments to define an operating scheme used by a BBCD. Process 200 will be described with reference to the system of FIG. 1. Process 200 may begin, for instance, when a user connects a BBCD of some embodiments to a mobile device and/or connects the BBCD to a power source.

The process then determines (at 210) whether a mobile device is connected. For instance, such a determination may be made by an element such as the connection module 135. The determination may be made in various appropriate ways (e.g., the connection module may be able to sense a signal from the mobile device, may be able to determine that a battery-powered device has been connected, etc.).

Next, the process determines (at 220) whether an external power source is connected. For instance, such a determination may be made by an element such as the charger 120. The determination may be made in various appropriate ways (e.g., the charger may be able to sense electricity supplied from the power source).

Process 200 then determines (at 230) whether an alternative power source is available. For instance, some embodiments may include an internal power sources such as alternative power source 140. The determination may be made, for instance, by an element such as the control module 130. The determination may be made in various appropriate ways (e.g., the control module may be able to receive a signal from the alternative power source, the control module may have a default setting that indicates an alternative power source is available, etc.).

Next, the process determines (at 240) a charge state of the mobile device battery (or batteries). For instance, such a determination may be made by an element such as the control module 130. The determination may be made in various appropriate ways (e.g., the control module may be able to communicate with the mobile device to receive the charge state from the mobile device, the control module may sense an output of the mobile device, etc.).

The process may then determine (at 250) a charge state of an internal battery of the BBCD (if available). For instance, such a determination may be made by an element such as the control module 130. The determination may be made in various appropriate ways (e.g., the control module may sense an output of the battery).

Next, process 200 defines (at 260) an operating scheme based at least partly on the information determined at operations 210-250. The operating scheme may include various appropriate parameters, algorithms, factors, etc. For instance, one operating scheme may receive power from an external source and charge a battery of the mobile device. As another example, a second operating scheme may receive power from an external source and charge an internal battery of the BBCD. As yet another example, a third operating scheme may receive power from an external source and charge both an internal battery of the BBCD and a battery of the mobile device.

In some embodiments, such charging schemes may be implemented such that charging current is optimized across batteries. For instance, if a battery of the primary user device is nearly discharged, the battery may receive all of the available charging current. As another example, if a battery of the primary user device is nearly charged, the battery may require only a small fraction of the available charging current. In such cases, some or all of the remaining available charging current may be provided to an external battery and/or external device, as appropriate.

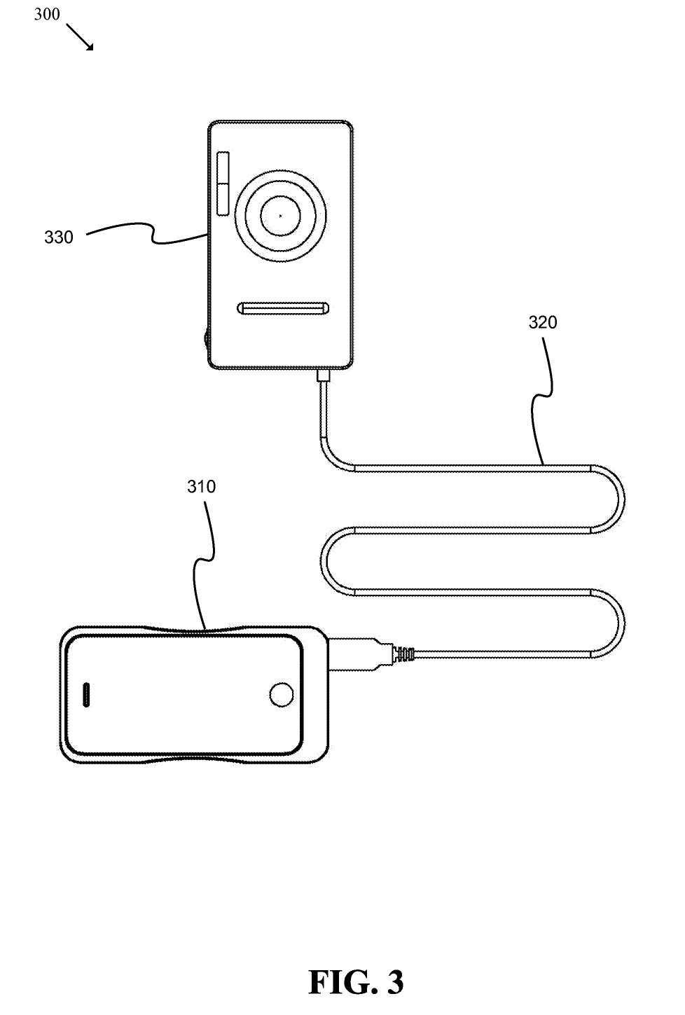

One of ordinary skill in the art will recognize that such operating schemes may be implemented in various appropriate ways. For instance, some schemes may divide power received from an external source such that a portion of the power is used to charge a mobile device battery and another portion is used to charge an internal battery of the BBCD. As another example, some schemes may receive power from an alternative power source in addition to or in place of power received from an external power source. The various operating schemes will be described in more detail in reference to FIGS. 3-6 below.

One of ordinary skill in the art will recognize that process 200 may be performed in various appropriate ways without departing from the spirit of the invention. For instance, the process may not be performed as one continuous series of operations in some embodiments. Alternatively, the process may be repeated, continuously or at regular or irregular intervals, in some embodiments. In addition, the process may be implemented using several sub-processes, or as part of a larger macro-process. Furthermore, various processes may be performed concurrently, sequentially, or some combination of sequentially and concurrently (e.g., certain operations of a first process may be performed concurrently with certain operations of a second process, while other operations of the first process may need to be completed before continuing to other operations of the second process). Moreover, the operations of the process may be performed in different orders.

FIG. 3 illustrates a connection scheme between a BBCD 310, a connecting cable 320 and an external device 330 that may be used to charge the internal battery of the external device. The BBCD 310 may include an input/output port (e.g., a universal serial bus (USB) port) used to charge external electronic devices using power from the BBCD's backup battery. For example, FIG. 3 illustrates the BBCD charging a battery of a digital camera 330 via a connecting cable 320. The external device 330 may be any electronic device that is able to draw power from an input/output port for charging (e.g., a camera, tablet, backup drive, other mobile device, etc.) and that is able to be connected to the BBCD 310.

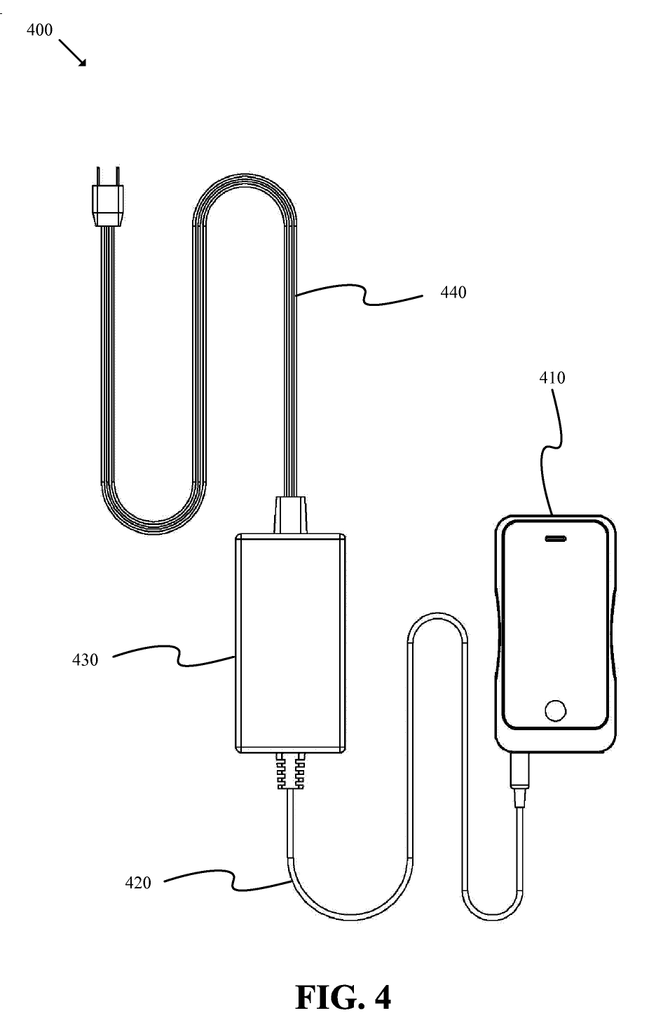

FIG. 4 illustrates the BBCD 410 electronically connected by a connecting cable 420 to an external secondary charging mechanism 430. Some embodiments of the BBCD 410 may include an input/output port that may allow the BBCD and the external secondary charging mechanism 430 to be charged from a power source (i.e., a standard wall outlet, cigarette charge outlet in a vehicle, etc.) via a cable connected between the power source 440 and the secondary charging mechanism 430. Such a secondary mechanism may be adapted to receive an AC input and generate a DC output that is appropriate for charging the mobile device 410.

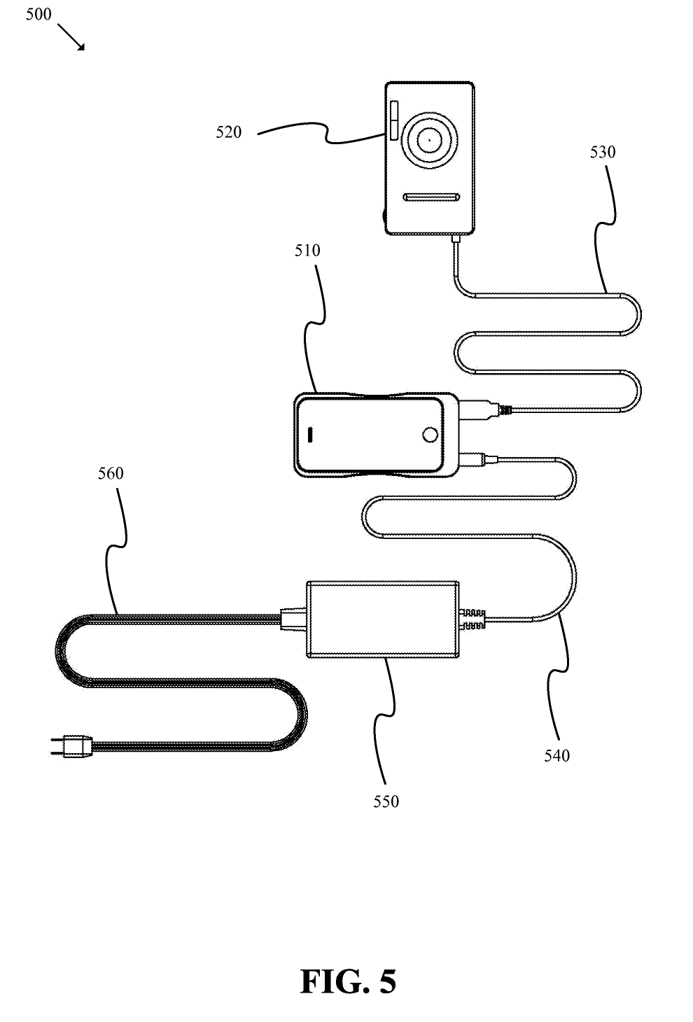

FIG. 5 illustrates an additional connection scheme of a BBDC 510 of some embodiments. As shown, the BBCD may be connected to a secondary external device 520 (e.g., a camera) via a first connecting cable 530. If a secondary external device 520 is also connected to the BBCD 510 as shown in FIG. 5, the BBCD, the electronic device coupled to the BBCD 550 via a second connecting cable 540 and the secondary external device 520 may all be charged simultaneously.

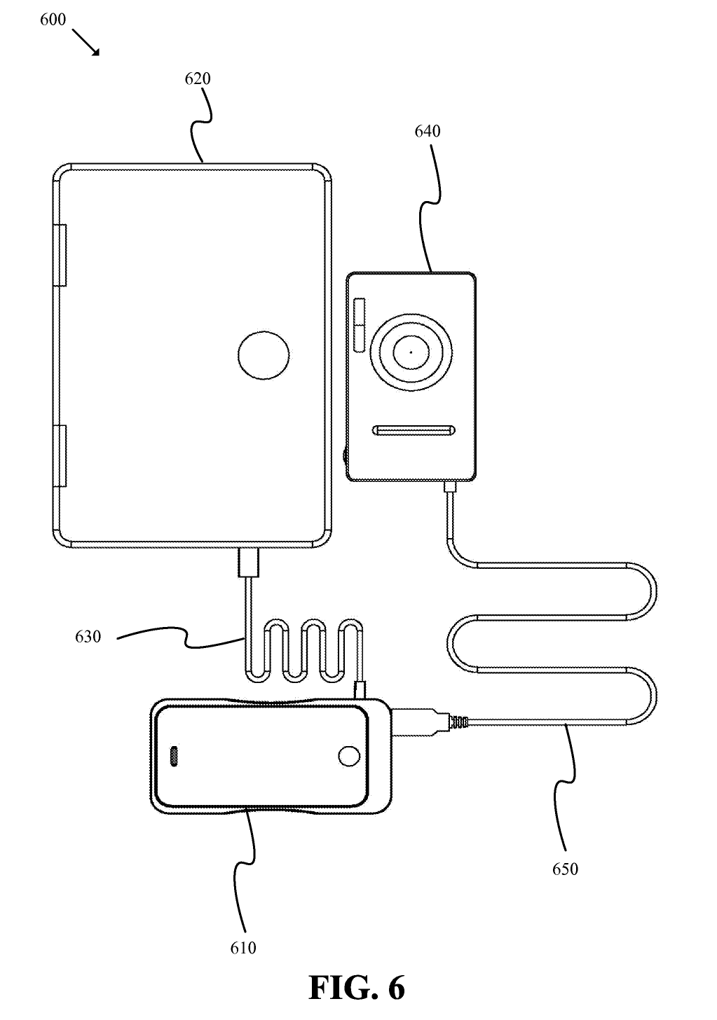

FIG. 6 illustrates the BBCD 610 electronically connected to a computing device 620 (e.g., a laptop, a tablet device, etc.) and a secondary external device 640 (e.g., a camera). Some embodiments of the BBCD 610 may include one or more input/output port(s) that may allow the BBCD to connect to a computing device 620 via a first connecting cable 630 and a secondary external device 640 via a second connecting cable 650. In this configuration, the BBCD 610 may draw power from the computing device 620 via the input/output port to simultaneously charge the BBCD 610, the electronic device coupled to the BBCD, and the secondary external device 640. Alternatively, in this configuration, if the BBCD is connected to an AC source, the BBCD may draw power from the AC sources and supply power to the secondary external device and/or the computing device.

One of ordinary skill in the art will recognize that the connection schemes described in FIGS. 3-6 are provided as examples only, and that different embodiments of the BBCD may be able to connect to other devices in various appropriate ways. In addition, some embodiments of the BBCD may allow a user to select from and/or define different charging and/or operating schemes that may be implemented using a single connection scheme (e.g., a user may connect first and second external devices to the BBCD and select an option to charge the BBCD and the external devices, the user may connect first and second external devices to the BBCD and select an option to charge the BBCD and the first external device while transferring data only with the second external device, etc.).

### II. Battery Backup and Charging Device

The charger of some embodiments may be sized to provide rapid charging to external and/or internal devices. In addition, the built-in charger may be designed with specific aspects to enhance battery life. The charger may be retractable such that a mobile device may be used if the external battery is being charged. Some embodiments may include an external boost feature with LED indication.

FIG. 7 illustrates a schematic block diagram of an exemplary embodiment of a BBCD 700 adapted to be used with a mobile device. Specifically, this figure shows various components that may be included in the BBCD. As shown, the BBCD includes an electro-mechanical interference (EMI) filter and input circuitry 705, an AC to DC converter 710, an output connection 715, a first set of LED indicators 720, a linear charger 725, a battery cell 730, another set of LED indicators 735, a boost converter 740, a first port 745, and a second port 750.

The EMI filter an input circuitry 705 may be adapted to buffer and filter an AC input signal and may include a fuse element. The EMI filter may include a set of input capacitors and at least one inductor that have values selected to meet the ripple, regulation, and EMI requirements of the charger 725. This input module 705 may be capable of accepting an input voltage of approximately 108V AC to 240V AC. Some embodiments of the AC to DC converter may include a planar transformer. Such a transformer may allow the BBCD to be implemented in a slim, low-profile housing. Such a planar transformer may include etched spiral patterns on a PCB that form the “windings” of the transformer.

The AC to DC converter 710 may be adapted to convert an AC voltage received from the input circuitry 705 into a DC voltage and may include a diode bridge that converts the AC input to a DC voltage in the range of approximately 130V to 380V. The AC conversion to an unregulated DC may be done using a bridge rectifier. The unregulated DC voltage may be transformed into low voltage thru high frequency flyback operating at 135 KHz or higher in some embodiments.

The high voltage DC output may be further converted to a lower voltage DC output (e.g., a 5.1V output). The AC to DC converter may also include a transformer that provides isolation between the input and output of the converter. The AC to DC converter may also include an opto-isolator that helps provide closed loop control and regulation in conjunction with a feedback circuit.

The output connection 715 may couple the output of the AC to DC converter 710 to an output of the boost converter 740 and/or to an output of the battery cell 730 (which may be connected through the boost converter 740). The first set of LED indicators 720 may be adapted to indicate a status of a mobile device connected to the BBCD 700.

The linear charger 725 may be adapted to receive a DC voltage from the AC to DC converter 710, and in turn, provide a charging output to the battery cell 730. The charger may receive input power from a flyback converter output. The device may include a high frequency integrated switcher with current sense and thermal sense capabilities. Such a switcher may provide quick charge and trickle charge capabilities, as appropriate. The charger 725 (and control circuitry of the flyback converter) may determine whether the internal or external battery will be charged, and/or what proportion of charging current will be provided to each battery. The determination of supplied charging current may be based at least partly on the current/charge profile of the internal and/or external battery. Charge current may be provided based at least partly on thermal, charge and/or load profiles of each of battery. In the case of a high temperature or battery failure, the circuit may be automatically turned off.

The battery cell may be adapted to store and supply charge to other components. The second set of LED indicators 735 may be adapted to indicate a status of the battery 730 and/or charger 725.

The boost converter 740 may be adapted to receive an output from the battery cell 730 and, in turn, to boost the received output to a higher level voltage output with increased current driving capability. The boost circuit may boost the battery voltage (e.g., 4.2V, a range from 3.0V to 4.2V, etc.) to 5.0V with approximately 1 A current capacity. In some embodiments, the boost converter may be turned off if an AC source is connected for charging purposes.

The boost output may be connected to a USB output switch as well as to the mobile device connector 745. Such a scheme may allow charging of the internal battery of the mobile device even if no power source is connected and the internal battery (of the mobile device) has a low charge. The USB output may be able to provide a charging current for an external device (e.g., a camera, drive, book reader, gaming device, etc.). In fact, any USB-powered device may be connected for charging.

The first port 745 may be adapted to supply DC power to a mobile device, and/or to allow communication with the mobile device. The second port 750 may be adapted to receive power from the alternative source and/or to communicate with the alternative source. For example, the second port may be able to accept power from a vehicle cigarette lighter adapter.

The various elements of the BBCD 700 may be directed by, communicate with, and/or otherwise interact with one or more control modules (e.g., processors, microcontrollers, etc.) and/or memory modules. In addition, various external controls (e.g., buttons, switches, etc.) may be provided. Such controls may at least partially direct the operations of the BBCD of some embodiments. For instance, some embodiments may include a power on/off button that is provided to the user such that the BBCD may be enabled or disabled, as appropriate.

During use, the input module 705 may receive AC power from an available source and deliver filtered power to the AC to DC converter 710. The AC to DC converter may receive an AC voltage from the input module 705 and provide a DC output to various other components (e.g., a charger, external device(s), internal components, etc.). The DC output may be provided to a mobile device through the output connection 715. The linear charger 725 may receive the DC output of the converter 710 and provide a charging output to the battery cell 730. The smart charging circuitry of some embodiments may charge any connected batteries in an optimized sequence. For instance, the mobile device battery may be charged first. Once the mobile device battery has started charging it will linearly draw a smaller amount of current. The unused current may be used to charge the external battery (e.g., battery cell 730) along with the internal mobile device battery. This allows a user to charge a mobile device and backup battery at twice the speed if connected to AC mains. The battery cell may be charged by the charge 725 and may provide power, through the boost converter 740, to the output connection 715. The boost converter may boost the output of the battery cell 730 under certain conditions, in order to facilitate rapid charging of an internal battery of the mobile device.

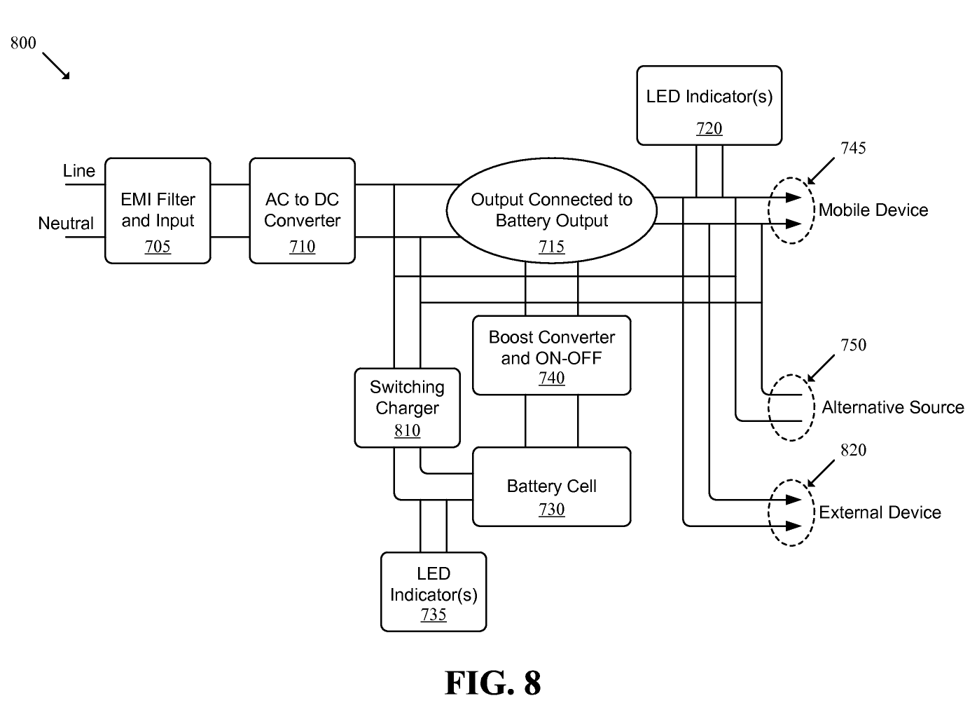

FIG. 8 illustrates a schematic block diagram of an exemplary embodiment of an alternative BBCD 800 adapted to be used with a mobile device. Specifically, in place of the linear charger 725, some embodiments may include a switching charger 810. In addition to the components described above in reference to FIG. 7, BBCD 800 may include a connection port 820 that may be connected to one or more external devices. Such a port may allow for charging of one or more additional device(s), communication to and/or from a computing device (e.g., sync from a personal computer to a mobile device), etc.

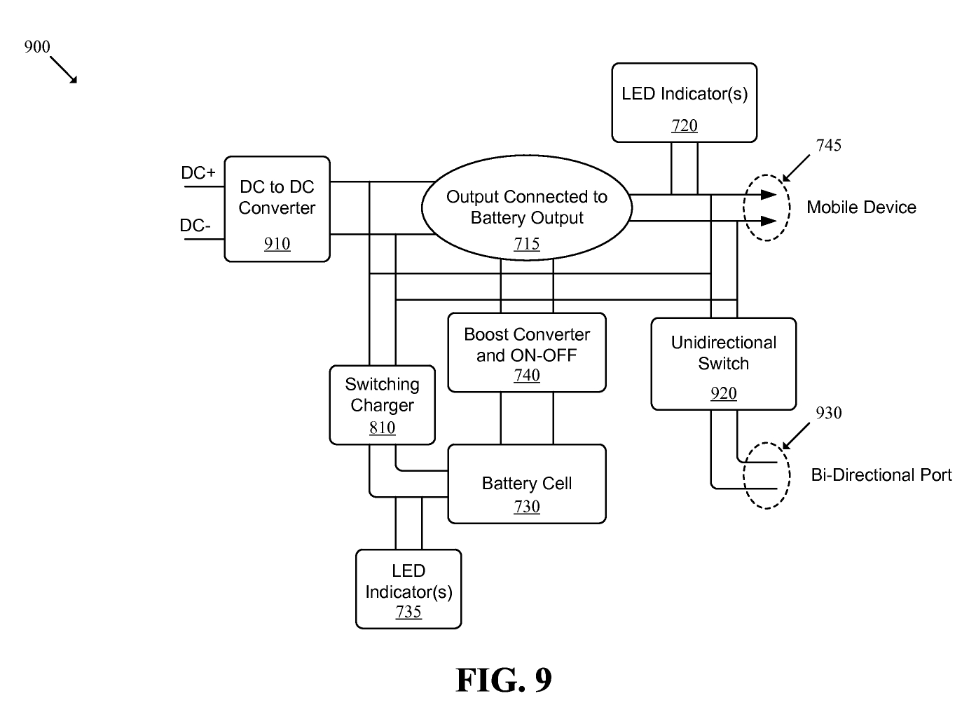

FIG. 9 illustrates a schematic of an exemplary embodiment of another alternative BBCD 900 adapted to be used with a personal computing device such as a laptop, tablet or PDA. Specifically, in addition to or in place of the components described above in reference to FIGS. 7-8, BBCD 900 may include a DC to DC converter 910, a unidirectional switch 920, and a bi-directional port 930.

The DC to DC converter 910 may be adapted to receive power from a DC source (e.g., a battery of a mobile device such as a notebook computer) and generate a DC output, where the input may be a larger voltage than the output (e.g., twelve to nineteen volts at the input and five volts at the output). The unidirectional switch 920 may be adapted to isolate the bi-directional port 930 from the output of the DC to DC converter 910 and/or the output of the battery 730. The bi-directional port 930 may allow communication (e.g., sync) among the mobile device housed with the BBCD and one or more external devices.

One of ordinary skill in the art will recognize that BBCDs 700-900 have been described with reference to particular details, but the invention may be practiced in various different ways with various different particular details without departing from the spirit of the invention. For instance, the system may include various other components (e.g., input and/or output devices, processing devices, memory, etc.). In addition, some embodiments may include components shown in different BBCDs (e.g., a single BBCD may include the AC to DC converter 710 of BBCD 700, the connection port 810 of BBCD 800, and the DC to DC converter 910 of BBCD 900).

In addition, some embodiments of the BBCD may include communication features that may allow mobile devices (of different type, manufacturer, etc.) to share information (e.g., by providing an external button). Some embodiments may also incorporate third party circuitry and/or software that may allow third party applications to run on the device (e.g., streaming video and/or audio).

### III. Operation

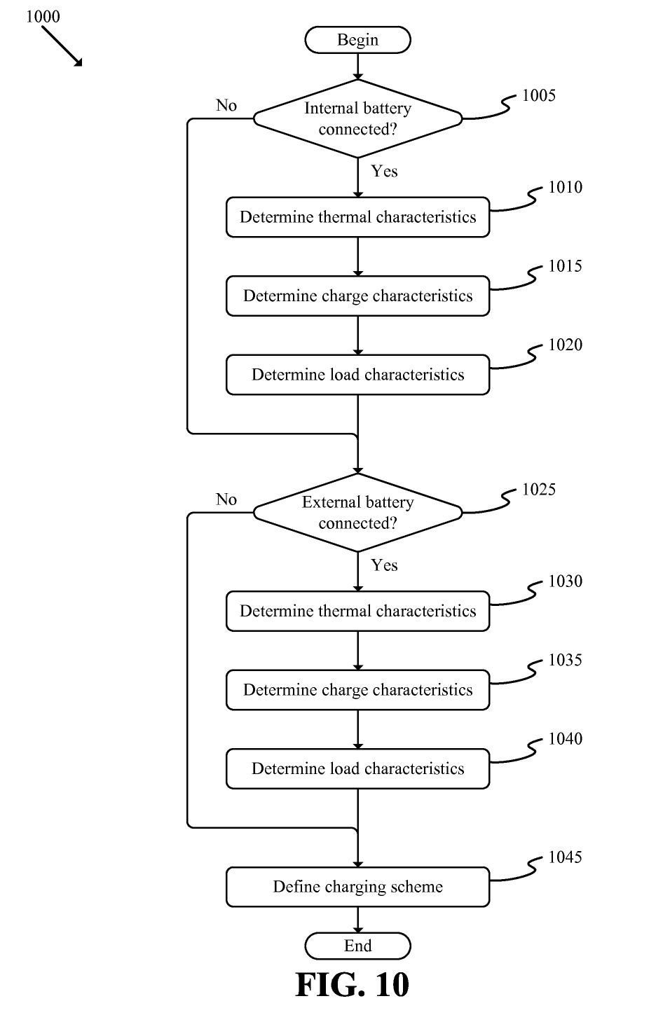

Various modes of operation are described in reference to FIGS. 10-13 below. One of ordinary skill will understand that such modes are conceptual in nature and may be implemented in various appropriate ways without departing from the spirit of the invention. In addition, one of ordinary skill will understand that a user and/or external application may be able to control and/or modify the operation of the modes described below, as appropriate. The modes of operation may be implemented by, for instance, various components described above in reference to the system 100 of FIG. 1 and/or the BBCDs 700, 800, and 900 of FIGS. 7-9.

FIG. 10 illustrates a flow chart of a conceptual process 1000 used by some embodiments to define a charging scheme. Such a process may start at various appropriate times (e.g., when a BBCD is connected to a charging source, when a BBCD is connected to an external device, etc.). The process may then determine (at 1005) whether an internal battery is connected. Such a determination may be made in various appropriate ways.

If the process determines (at 1005) that an internal battery is connected, the process may then determine (at 1010) the thermal characteristics of the battery, determine (at 1015) the charge characteristics of the battery, and determine (at 1020) the load characteristics of the battery. Such determinations may be made in various appropriate ways, based on various appropriate inputs. After determining the thermal, charge, and load characteristics of the battery, or after determining (at 1005) that an internal battery is not connected, the process may determine (at 1025) whether an external battery is connected.

If the process determines (at 1025) that an external battery is connected, the process may then determine (at 1030) the thermal characteristics of the battery, determine (at 1035) the charge characteristics of the battery, and determine (at 1040) the load characteristics of the battery. Such determinations may be made in various appropriate ways, based on various appropriate inputs. After determining the thermal, charge, and load characteristics of the battery, or after determining (at 1025) that an internal battery is not connected, the process may define (at 1045) a charging scheme, based at least partly on the determined information regarding the internal and/or external batteries.

The charging scheme may be based on various relevant factors (e.g., voltage level of each battery, power sources available for charging, etc.). In addition, the charging scheme may be based on various pre-set or default conditions. The charging scheme may be defined such that any available charging voltage and/or current is optimally used by any available devices with chargeable batteries.

One of ordinary skill in the art will recognize that process 1000 may be performed in various appropriate ways without departing from the spirit of the invention. For instance, the process may not be performed as one continuous series of operations in some embodiments. Alternatively, the process may be repeated, continuously or at regular or irregular intervals, in some embodiments. In addition, the process may be implemented using several sub-processes, or as part of a larger macro-process. Furthermore, various processes may be performed concurrently, sequentially, or some combination of sequentially and concurrently (e.g., certain operations of a first process may be performed concurrently with certain operations of a second process, while other operations of the first process may need to be completed before continuing to other operations of the second process). Moreover, the operations of the process may be performed in different orders.

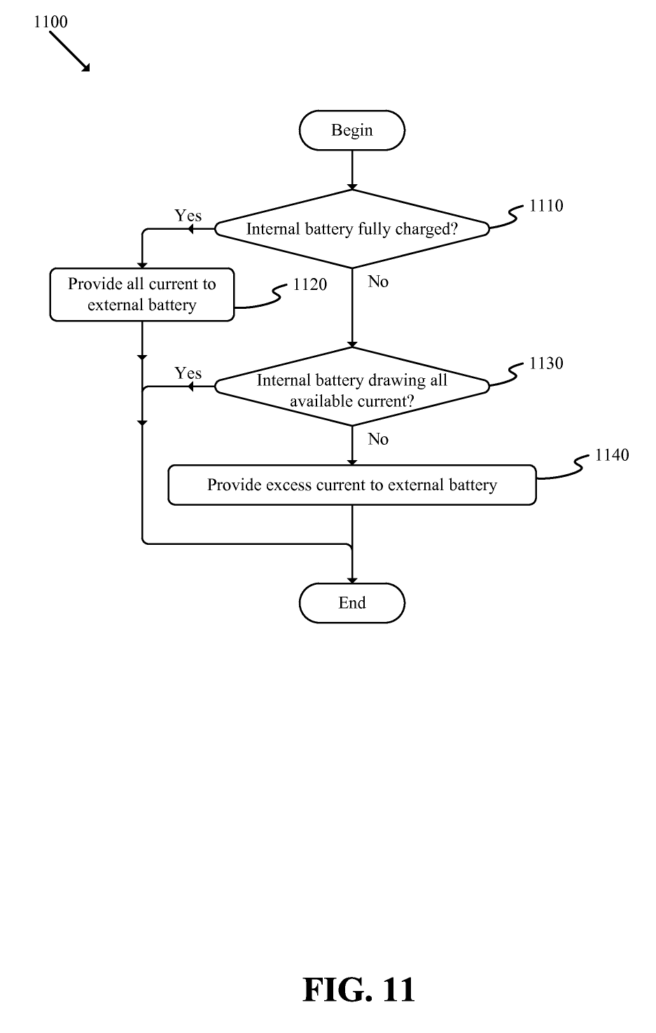

FIG. 11 illustrates a flow chart of a conceptual process 1100 used by some embodiments to optimize usage of available charging capacity. Such a process may start at various appropriate times (e.g., when a BBCD is connected to a charging source, when a BBCD is connected to an external device, etc.).

The process may then determine (at 1110) whether an internal battery of the connected device is fully charged. Such a determination may be made in various appropriate ways. If the process determines (at 1110) that an internal battery is fully charged, the process may provide (at 1120) all available current to an external battery and then may end.

If, on the other hand, the process determines (at 1110) that an internal battery is not fully charged, the process may then determine (at 1130) whether an internal battery is drawing all available current. If the process determines (at 1130) that an internal battery is drawing all available current, the process may end.

If the process determines (at 1130) that an internal battery is not drawing all available current, the process may provide (at 1140) excess current to an external battery (e.g., a battery of the BBCD) and end. Such determinations may be made in various appropriate ways, based on various appropriate inputs.

In this way, process 1100 allows maximum utilization of any available charging current. When all batteries are discharged, the internal battery of the connected device is charged using the full charging capability. As the internal battery has become partially charged, it may draw less current. Normally, such excess current is not able to be utilized. However, process 1100 may make the excess current available to an external battery (and/or a battery of an external device) such that multiple batteries may be charged in parallel.

One of ordinary skill in the art will recognize that process 1100 may be performed in various appropriate ways without departing from the spirit of the invention. For instance, the process may not be performed as one continuous series of operations in some embodiments. Alternatively, the process may be repeated, continuously or at regular or irregular intervals, in some embodiments. In addition, the process may be implemented using several sub-processes, or as part of a larger macro-process. Furthermore, various processes may be performed concurrently, sequentially, or some combination of sequentially and concurrently (e.g., certain operations of a first process may be performed concurrently with certain operations of a second process, while other operations of the first process may need to be completed before continuing to other operations of the second process). Moreover, the operations of the process may be performed in different orders.

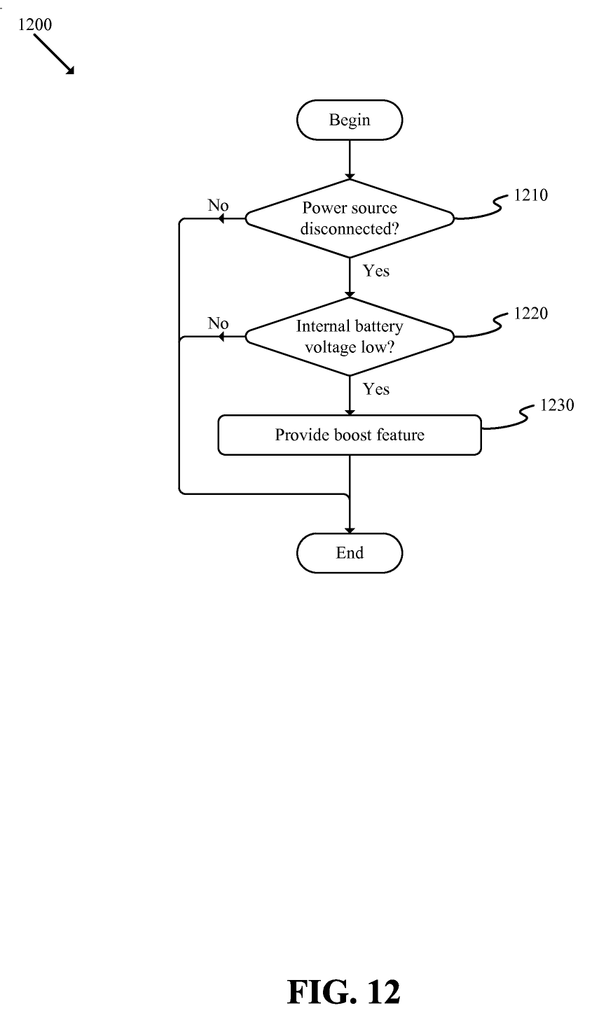

FIG. 12 illustrates a flow chart of a conceptual process 1200 used by some embodiments to initiate a boost feature of the BBCD. Such a process may start at various appropriate time (e.g., when a BBCD of some embodiments is activated, when the boost feature is enabled by a user, etc.).

Next, the process may determine (at 1210) whether a power source is disconnected from the BBCD. If the process determines (at 1210) that a power source is disconnected (i.e., that no power source(s) are connected), the process may then determine (at 1220) whether the internal battery voltage of the connected device is low. If the process determines (at 1220) that the internal battery voltage is low, the process may then provide (at 1230) a boost feature to the BBCD.

If the process determines (at 1210) that a power source is connected, or determines (at 1220) that the internal battery voltage is not low, the process may end.

One of ordinary skill in the art will recognize that process 1200 may be performed in various appropriate ways without departing from the spirit of the invention. For instance, the process may not be performed as one continuous series of operations in some embodiments. Alternatively, the process may be repeated, continuously or at regular or irregular intervals, in some embodiments. In addition, the process may be implemented using several sub-processes, or as part of a larger macro-process. Furthermore, various processes may be performed concurrently, sequentially, or some combination of sequentially and concurrently (e.g., certain operations of a first process may be performed concurrently with certain operations of a second process, while other operations of the first process may need to be completed before continuing to other operations of the second process). Moreover, the operations of the process may be performed in different orders.

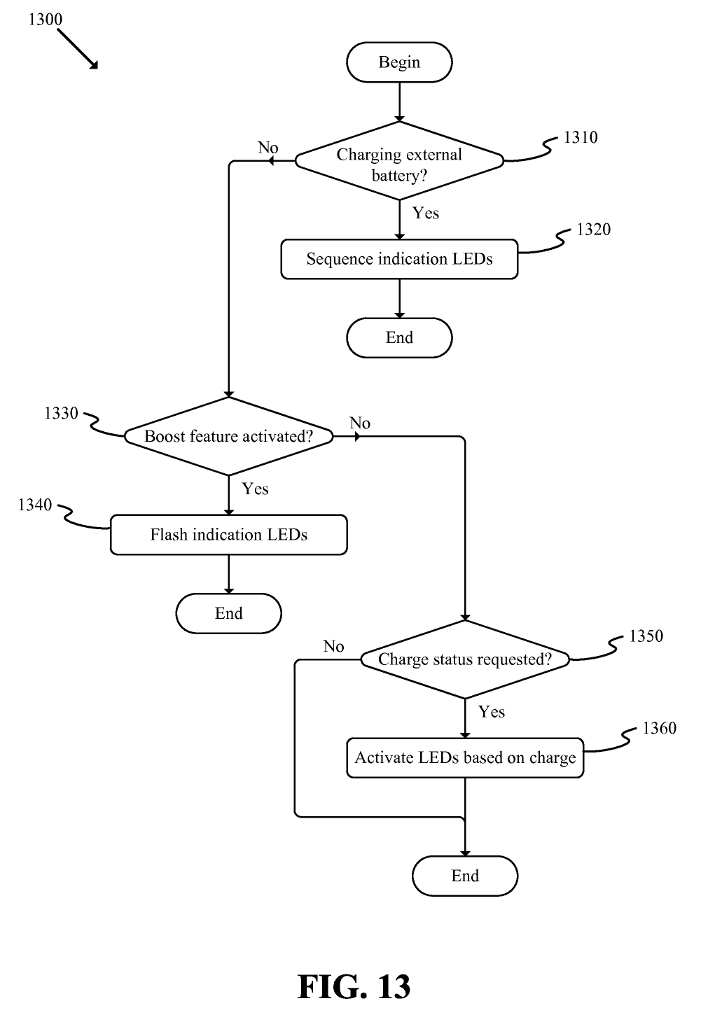

FIG. 13 illustrates a flow chart of a conceptual process 1300 used by some embodiments to display the status of the BBCD to a user. The process may begin at various appropriate times (e.g., when the BBCD is charging one or more devices, when a user requests an update, etc.).

Next, the process may determine (at 1310) whether the BBCD is charging an external battery. If the process determines (at 1310) that the BBCD is charging an external battery using an AC or external source, the process may sequence (at 1320) a set of indication LEDs (or other appropriate display indicator). For example, four LEDs may repeatedly be lit in sequence and then unlit as the battery charges. The number of LEDs that are lit may indicate the current charge level (e.g., one LED may be lit when the battery is nearly discharged, two LEDs lit when the battery is halfway charged, etc.). Such sequencing of LEDs may be continued as long as the external battery is being charged. After sequencing the LEDs, the process may end.

If the process determines (at 1310) that the BBCD is not charging an external battery, the process may determine (at 1330) whether the boost feature is activated. If the process determines (at 1330) that the boost feature is activated, the process may flash (at 1340) a set of indication LEDs. In some embodiments, the number of LEDs that flash may indicate the charge of the battery. The LEDs may continuously flash as long as the boost feature is activated. After flashing the LEDs, the process may end.

If the process determines (at 1330) that the boost feature is not activated, the process may determine (at 1350) whether a charge status is requested. Such a request may be generated when a user presses a button on the BBCD, for instance. If the process determines (at 1350) that the charge status is requested, the process may activate (at 1360) LEDs based on charge. Each LED may be activated in sequence and the set of activated LEDs may indicate a relative charge level (e.g., three out of four LEDs being activated may indicate a seventy-five percent charge). The display of activated LEDs may be continued for an appropriate length of time (e.g., four seconds) before the process may end. If the process determines (at 1350) that the charge status is not requested, the process may end.

One of ordinary skill in the art will recognize that process 1300 may be performed in various appropriate ways without departing from the spirit of the invention. For instance, the process may not be performed as one continuous series of operations in some embodiments. Alternatively, the process may be repeated, continuously or at regular or irregular intervals, in some embodiments. In addition, the process may be implemented using several sub-processes, or as part of a larger macro-process. Furthermore, various processes may be performed concurrently, sequentially, or some combination of sequentially and concurrently (e.g., certain operations of a first process may be performed concurrently with certain operations of a second process, while other operations of the first process may need to be completed before continuing to other operations of the second process). Moreover, the operations of the process may be performed in different orders.

### IV. Housings

Various example housings are described below in reference to FIGS. 14-38. One of ordinary skill in the art will recognize that the example housings described below are for illustrative purposes only and that different embodiments may be implemented in various different ways in order to support various specific devices, as appropriate.

A. Exemplary Mobile Device Housing

The following sub-section describes, with reference to FIGS. 14-18, an exemplary mobile device housing of some embodiments. Such a housing may be adapted to be used with a variety of devices and/or device manufacturers, as appropriate.

FIG. 14 illustrates first 1410 and second 1420 perspective views of one embodiment of a mobile device (e.g., a mobile phone) encased in a housing 1430 that includes a BBCD.

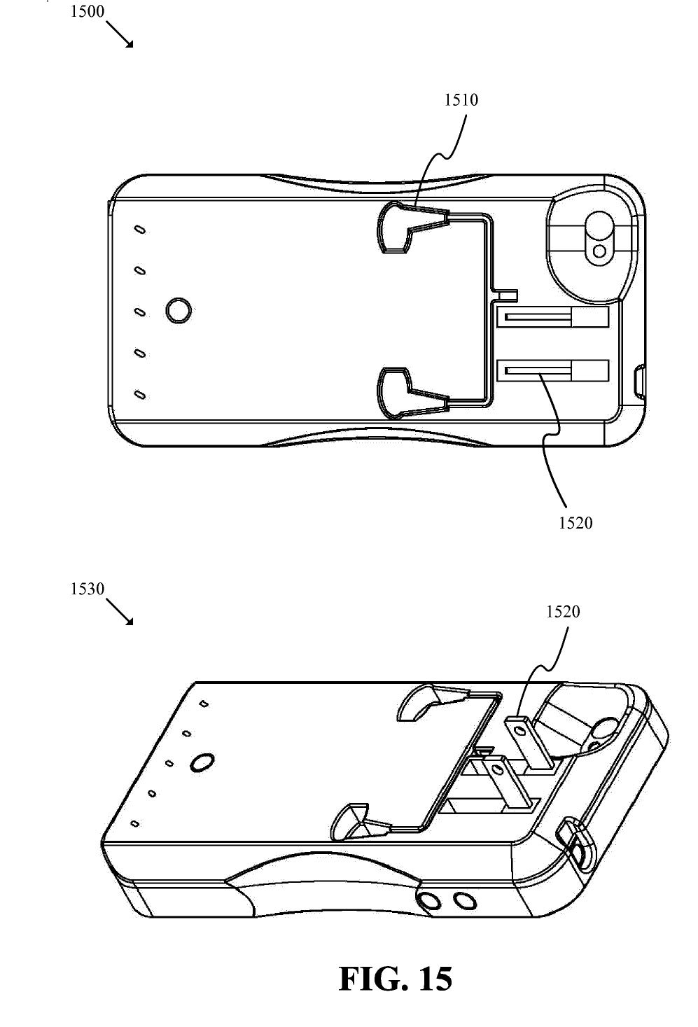

FIG. 15 illustrates a rear view 1500 of the BBCD housing of FIG. 14. As shown, some embodiments of the present invention may include a recess 1510 for storing retractable headphones for use with the mobile device (e.g., a smartphone). Some embodiments may also include AC prongs 1520, which may be folded into or be retractable from the housing of the BBCD, for use with a wall outlet for easy charging of the BBCD and the device connected to the BBCD.

FIG. 15 further illustrates a second perspective view 1530 of the BBCD housing 1430 with the AC prongs 1520 extended. Some embodiments of the AC prongs may flip or pop out of the BBCD while other embodiments may allow the AC prongs to be pulled out via a retractable mechanism inside the BBCD housing 1430. The AC prongs 1520 of some embodiments may also differ based on their placement in different regions of the BBCD housing 1430. The AC prongs 1520 may include defined positions (e.g., open, closed) where the prongs may be locked in place (e.g., such that the prongs do not extend from the housing when not in use, and/or such that the prongs form a rigid ninety degree angle with a face of the housing 1430.

Some embodiments of the BBCD may allow the device to be charged from standard U.S. outlets and/or various types of International outlets (e.g., using various adapters, connectors, etc.). The BBCD may be able to receive an electric input in a range of approximately eighty-five volts AC to two hundred and sixty volts AC. If the BBCD is attached to an AC outlet, the BBCD may be able to charge both the internal battery of the electronic device housed with the BBCD and the backup battery stored in the BBCD, wither in parallel or in series. The BBCD may also keep each battery charged at a certain level to increase the life of both the electronic device battery and the backup battery. One of ordinary skill in the art would recognize that the BBCD may include various different types of AC prongs (and/or other types of power connectors).

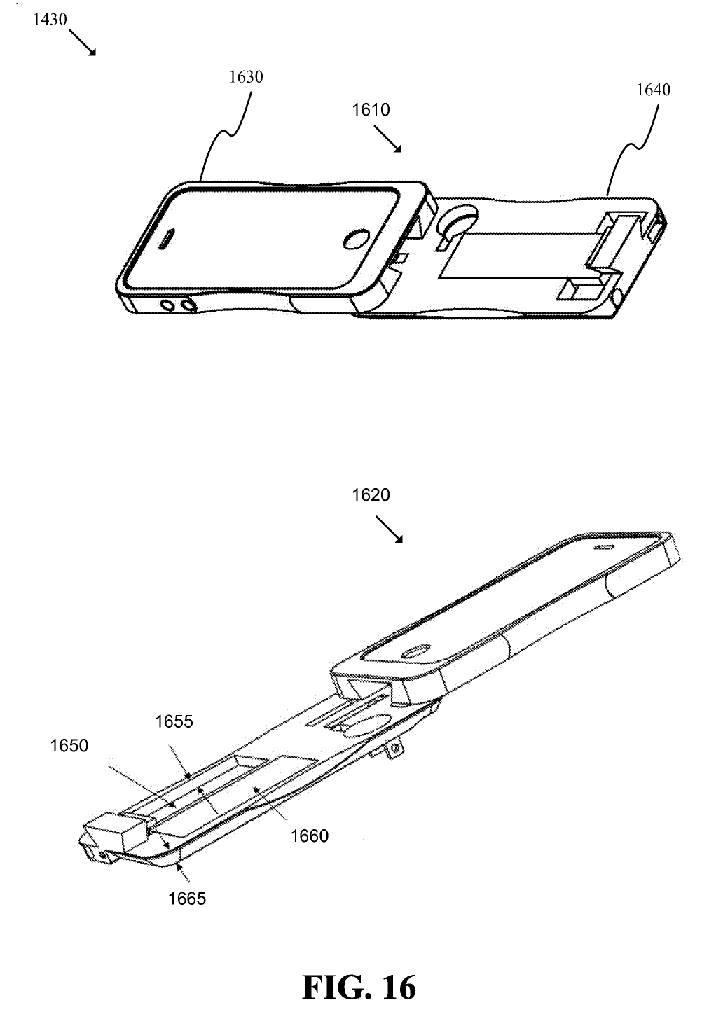

FIG. 16 illustrates first and second perspective views 1610-1620 of a BBCD housing 1430 of some embodiments, showing a way the BBCD housing may be secured and electronically coupled to a mobile device. In some embodiments of the present invention a mobile device may be secured to the device using front and back plates 1630-1640. The front plate 1630 may sit on top of the mobile phone and the back plate 1640 may slide over the bottom of the mobile device. The front and back plates may have interlocking parts that fasten the front and back plates to each other and secure the mobile device.

As shown, the back plate 1640 of some embodiments may include a first recess 1650 having a first depth 1655 (e.g., five millimeters) and second recess 1660 which may each fit into the depth 1665 (e.g., six-and-a-half millimeters) of the back plate. The first recess 1650 may house, for instance, electronic components of the BBCD (e.g., a printed circuit board or (PCB) and various components attached thereto may be included in the recess). The second recess 1660 may house, for instance, a backup battery provided by some embodiments of the BBCD. If the front and back plates are secured to a mobile device the housing (and, in turn, the BBCD) may be electrically coupled to input/output communication connections of the mobile device (e.g., a socket provided by the mobile device).

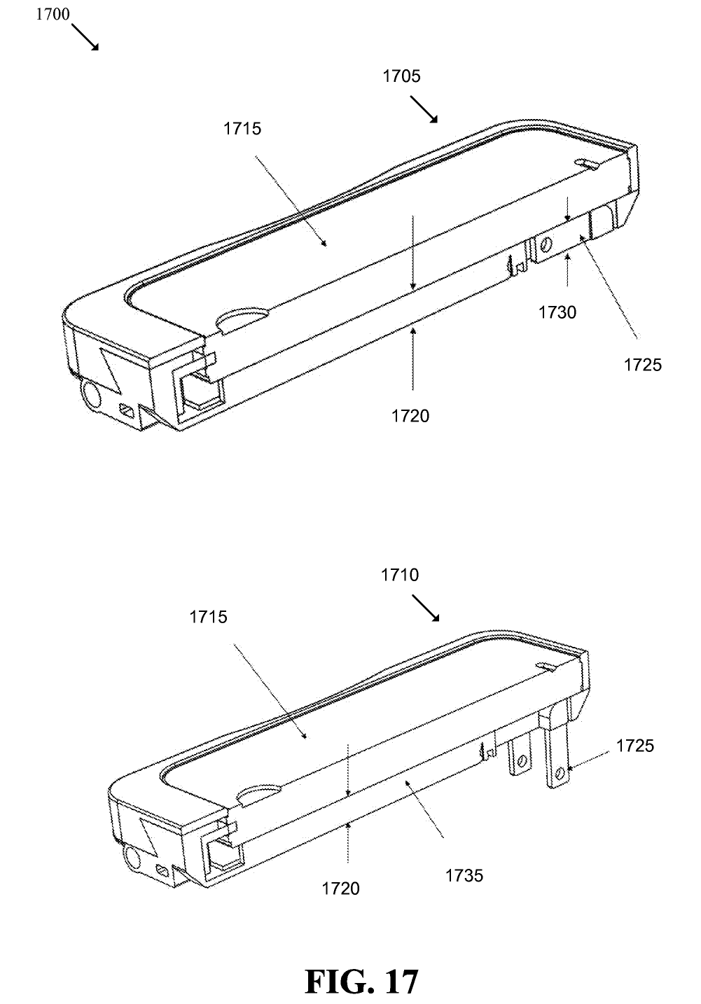

FIG. 17 illustrates first 1705 and second 1710 perspective section views of a BBCD housing of some embodiments. As shown, the BBCD housing may hold and protect a mobile device 1715. The additional thickness 1720 of the BBCD may be slim for convenient carrying (e.g., six-and-a-half millimeters), may include an AC plug 1725 that may have an appropriate thickness 1730 (e.g., five millimeters). The BBCD may include a back plate 1735 that may house the AC plug, ear buds, a cable winder, PCBs, various electronics, battery, and/or other appropriate components.

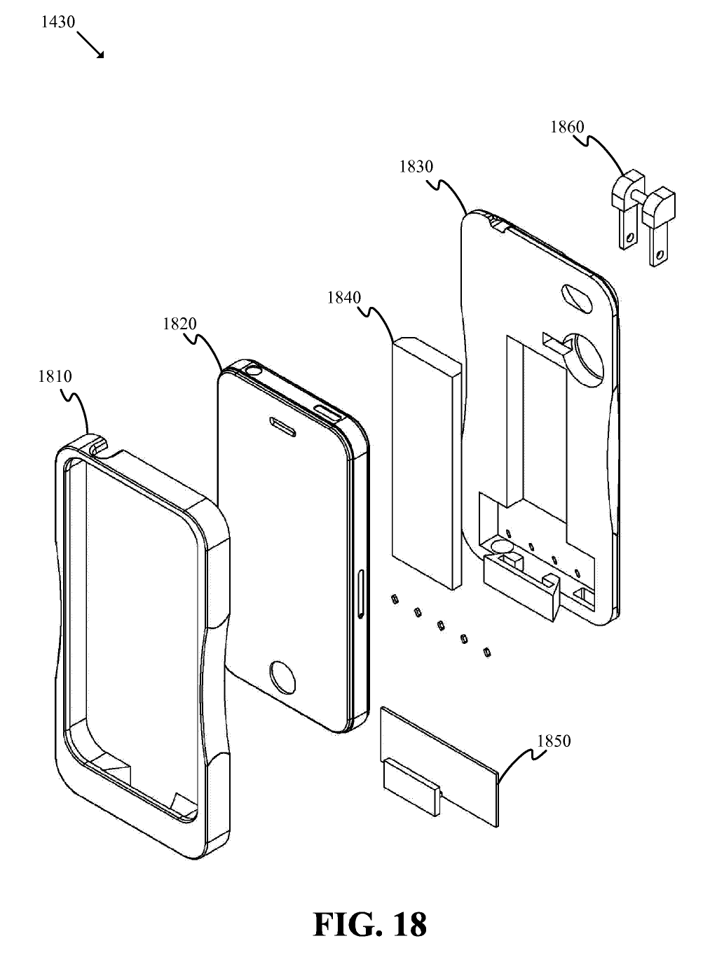

FIG. 18 illustrates an exploded view of the BBCD housing 1430. As shown, some embodiments may include a front plate 1810 that may be adapted to cover a front face of a mobile device 1820. In addition, the housing 1430 may include a back plate 1830 that may be adapted to cover the rear face of the mobile device 1820. The back plate 1830 may house a battery 1840 or other components. Such components may be secured using a retention element 1850. The back plate 1830 may also include AC prongs 1860. In one embodiment of the present invention, the backup battery or batteries 1840 that are stored within the BBCD may be approximately three mm to seven mm in height in order to preserve a thin profile for the BBCD if attached to a mobile device 1820. The battery 1840 of some embodiments of the BBCD may provide approximately eight to ten hours or more of additional operation for the attached mobile device.

B. Exemplary Mobile Device Housing with Removable Charger

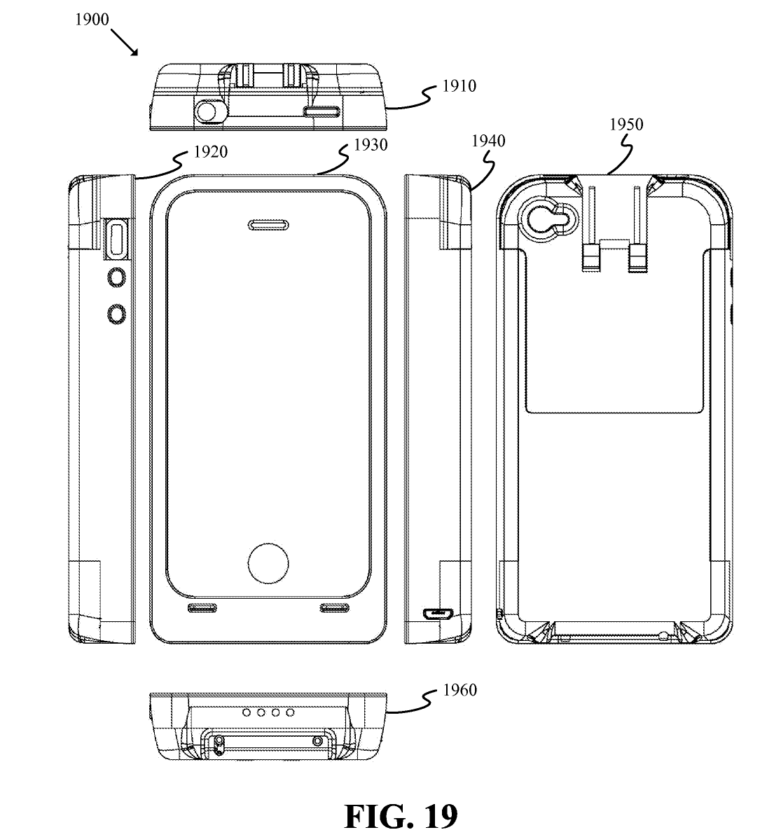

The following sub-section describes, with reference to FIGS. 19-27, an exemplary mobile device housing with a removable charger of some embodiments. Such a housing may be adapted to be used with a variety of devices and/or device manufacturers, as appropriate.

FIG. 19 illustrates various views of a BBCD housing 1900 of some embodiments. As shown, the figure includes a top view 1910, a left side view 1920, a front view 1930, a right side view 1940, a rear view 1950, and a bottom view 1960. The example housing 1900 may include various modules and features described above in reference to FIGS. 7-9.

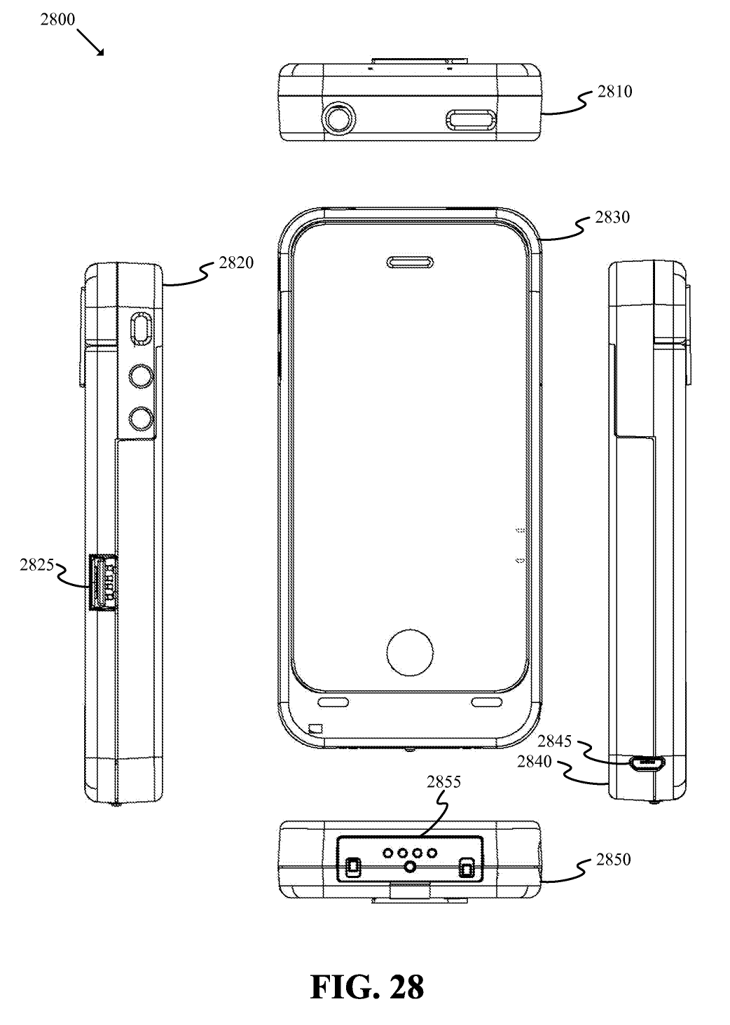

As described in more detail below in reference to FIGS. 28-31, the housing 1900 of some embodiments may include a removable component that may include various sub-components of the BBCD (e.g., AC prongs, charger, and battery). In this way, a user may be able to use the mobile device while the removable component may be plugged into an AC outlet to charge the backup battery.

The housing 1900 may include various features that may provide access to controls and/or features of a mobile device housed therein. For instance, some embodiments may include a cutout to expose a headphone jack provided by the mobile device. As another example, some embodiments may include cutout or transparent sections to allow use of a camera included in the mobile device.

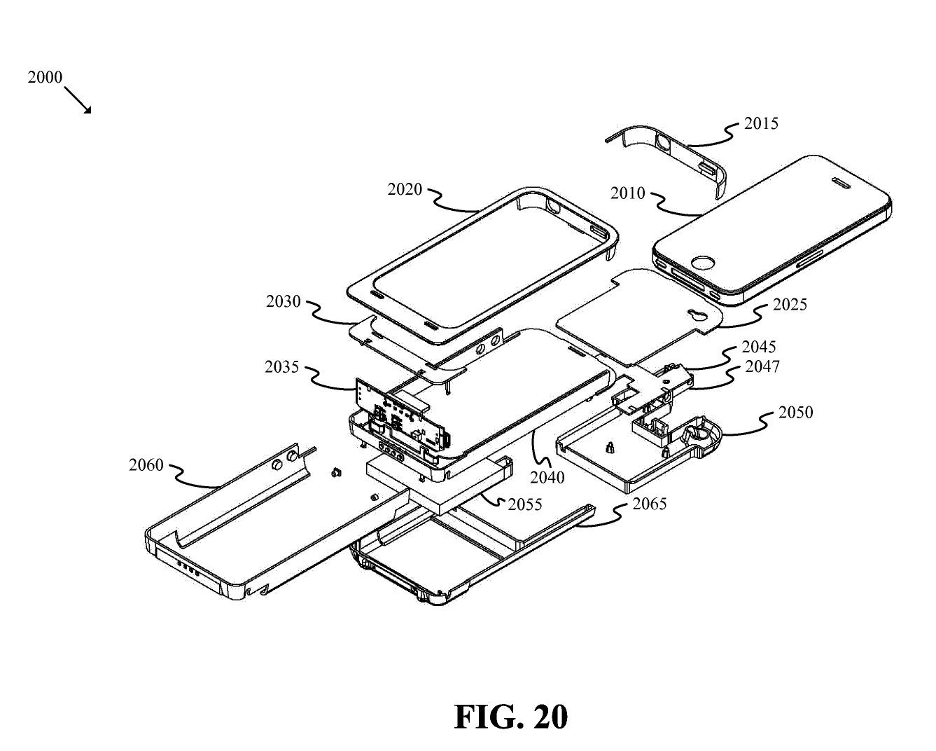

FIG. 20 illustrates an exploded view 2000 of the BBCD housing 1900. As shown, the BBCD housing may include various components for housing a mobile device 2010. Such components may include a top cover 2015, a front face 2020, a backing element 2025, a retaining element 2030, a PCB 2035 and/or other electronic components, a rear retaining plate 2040, a PCB 2045 and/or other electronic components, a set of AC prongs 2047, a removable charger housing 2050, a battery 2055, a side cover 2060, and a rear face 2065.

Such components may be adapted as appropriate to fit various types of phones and/or to provide various functions and/or components. The components of the housing 1900 may be particularly optimized to minimize size, based on the dimensions of the mobile device 2010.

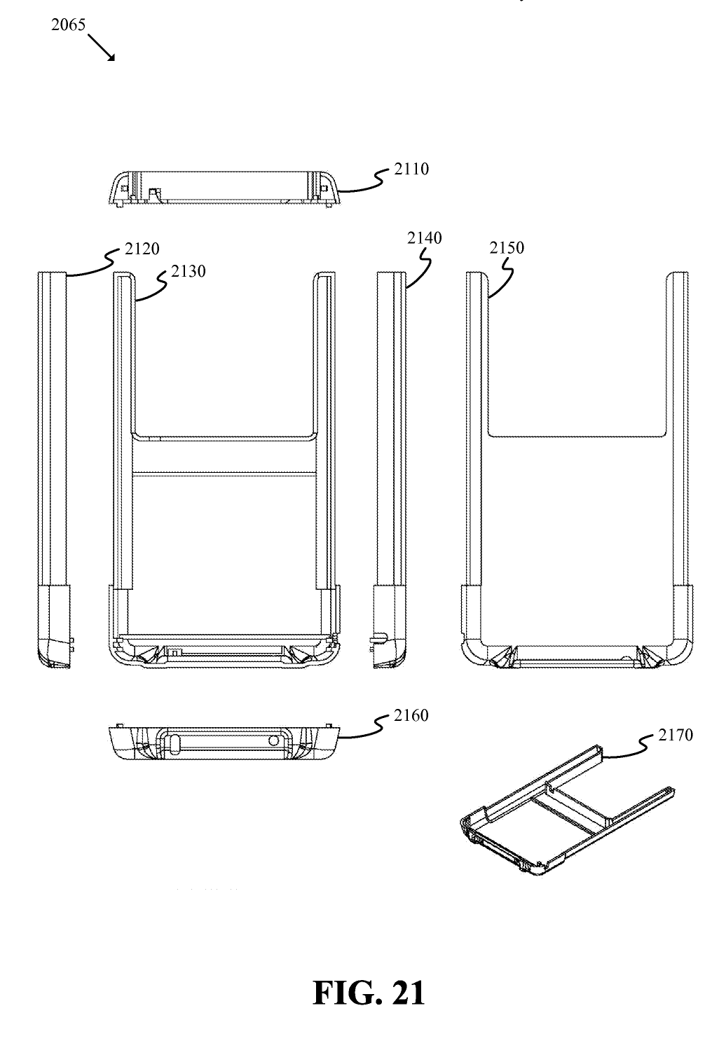

FIG. 21 illustrates various views of the rear face 2065 of some embodiments of the housing 1900. As shown, the figure includes a top view 2110, a left side view 2120, a front view 2130, a right side view 2140, a rear view 2150, a bottom view 2160, and a perspective view 2170.

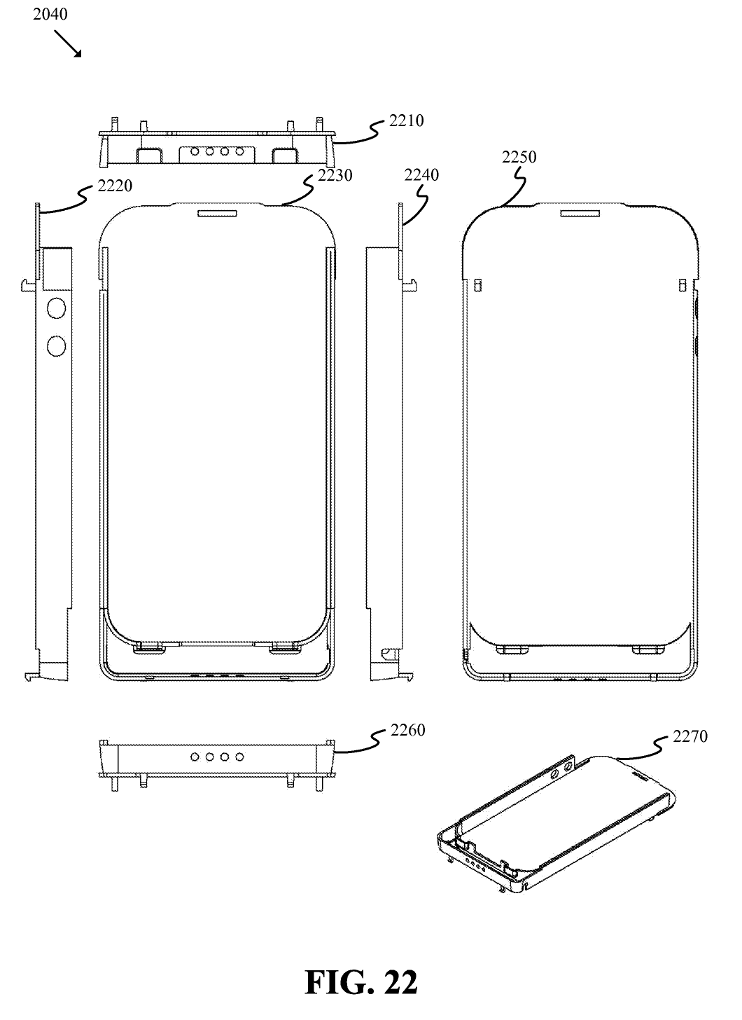

FIG. 22 illustrates various views of the rear retaining plate 2040 of some embodiments of the housing 1900. As shown, the figure includes a top view 2210, a left side view 2220, a front view 2230, a right side view 2240, a rear view 2250, a bottom view 2260, and a perspective view 2270.

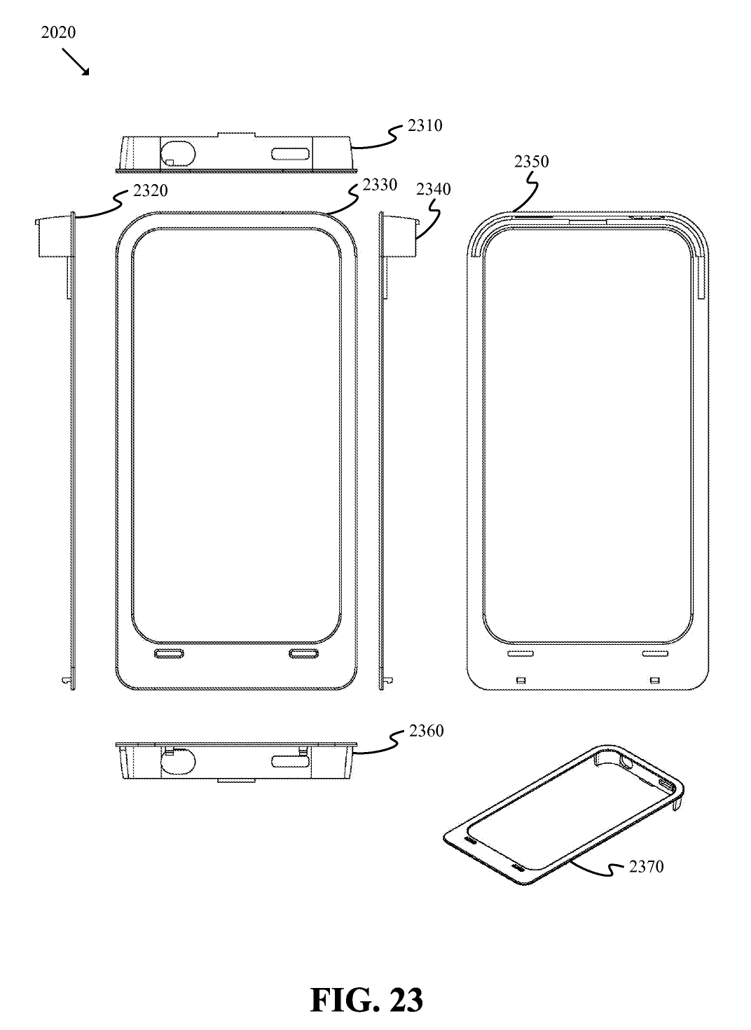

FIG. 23 illustrates various views of the front face 2020 of some embodiments of the housing 1900. As shown, the figure includes a top view 2310, a left side view 2320, a front view 2330, a right side view 2340, a rear view 2350, a bottom view 2360, and a perspective view 2370.

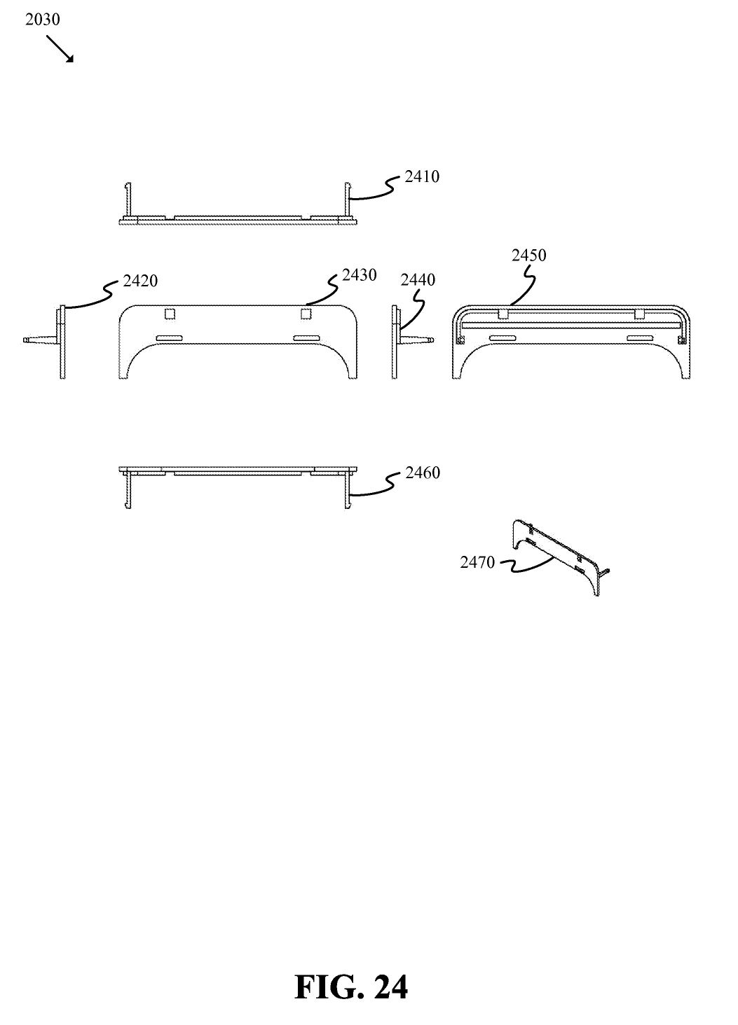

FIG. 24 illustrates various views of the retaining element 2030 of some embodiments of the housing 1900. As shown, the figure includes a top view 2410, a left side view 2420, a front view 2430, a right side view 2440, a rear view 2450, a bottom view 2460, and a perspective view 2470.

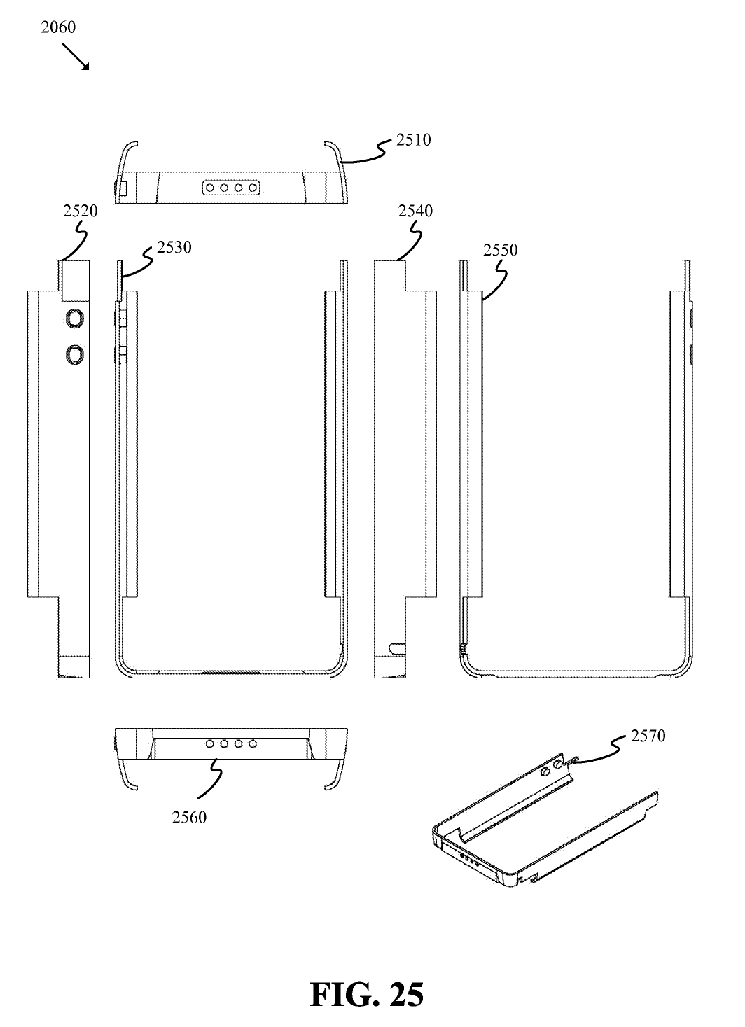

FIG. 25 illustrates various views of the side cover 2060 of some embodiments of the housing 1900. As shown, the figure includes a top view 2510, a left side view 2520, a front view 2530, a right side view 2540, a rear view 2550, a bottom view 2560, and a perspective view 2570.

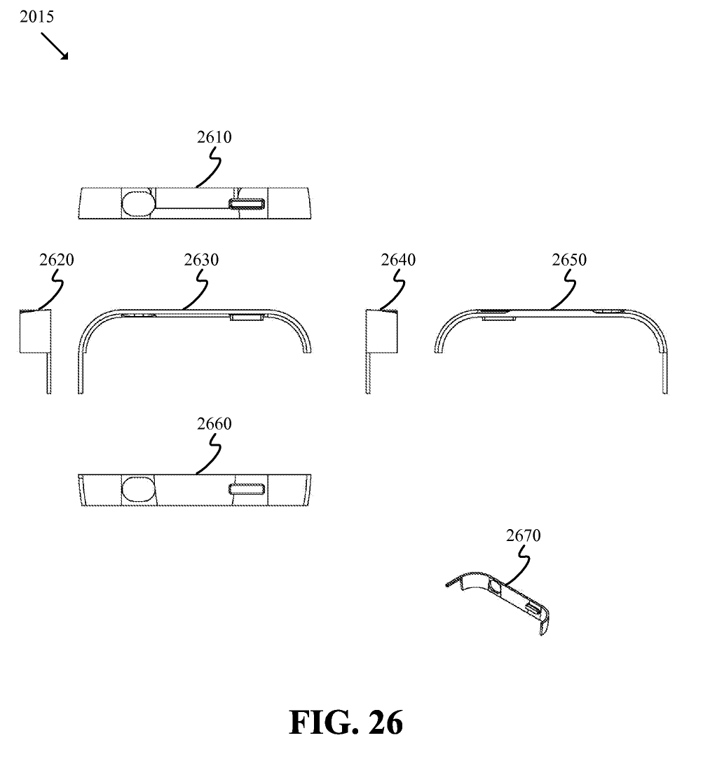

FIG. 26 illustrates various views of the top cover 2015 of some embodiments of the housing 1900. As shown, the figure includes a top view 2610, a left side view 2620, a front view 2630, a right side view 2640, a rear view 2650, a bottom view 2660, and a perspective view 2670.

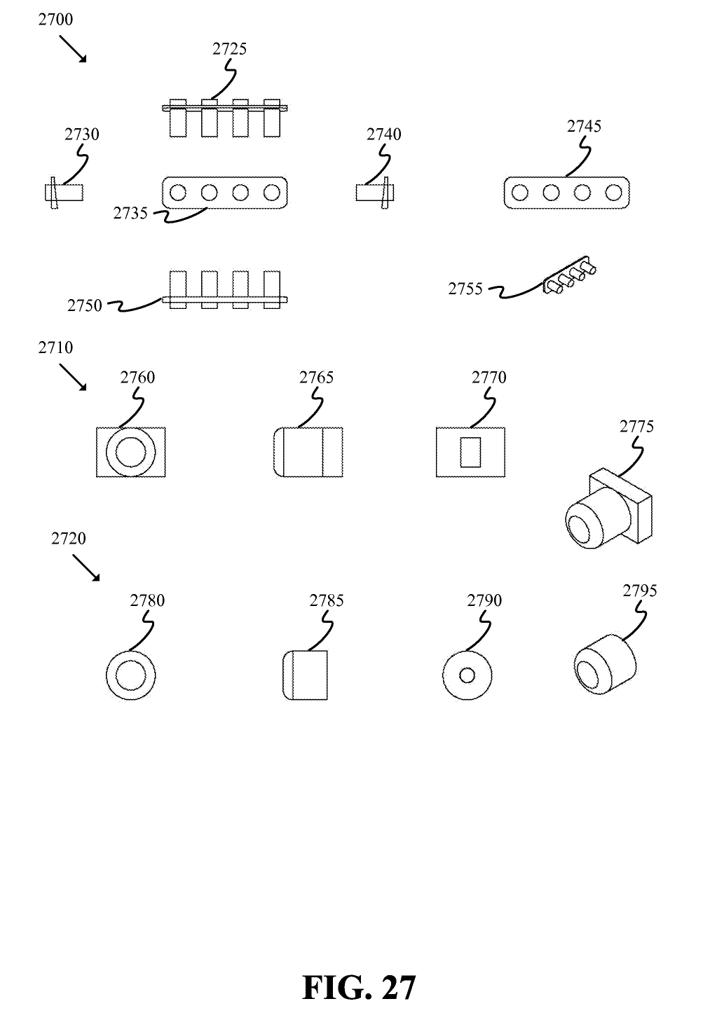

FIG. 27 illustrates various views of a set of lenses 2700 and caps 2710 and 2720 that may be included in some embodiments of the housing 1900. As shown, the figure includes a top view 2725, a left side view 2730, a front view 2735, a right side view 2740, a rear view 2745, a bottom view 2750, and a perspective view 2755 of the set of lenses 2700. The figure also includes a front view 2760, a side view 2765, a rear view 2770, and a perspective view 2775 of cap 2710. In addition, the figure includes a front view 2780, a side view 2785, a rear view 2790, and a perspective view 2795 of cap 2720.

C. Alternative Exemplary Mobile Device Housing with Removable Charger

The following sub-section describes, with reference to FIGS. 19-29, an alternative exemplary mobile device housing with removable charger of some embodiments. Such a housing may be adapted to be used with a variety of devices and/or device manufacturers, as appropriate.

FIG. 28 illustrates various views of an alternative BBCD housing 2800 of some embodiments. As shown, the figure includes a top view 2810, a left side view 2820 (which shows a USB port 2825), a front view 2830, a right side view 2840 (which shows a micro-USB port 2845), and a bottom view 2850 (which shows a display element 2855). The example housing 2800 may include various modules and features described above in reference to FIGS. 7-9.

The USB port 2825 may be used to charge external devices. The micro-USB port 2845 may be used to charge the internal battery from an external source (and/or to communicate with an external device). The display element 2855 may include one or more LEDs (and/or other appropriate indicators) that may provide information to a user regarding charge status, power level of the internal and/or external battery, boost feature status, and/or any other appropriate information. Such a display element may be placed on a top, side or bottom portion of the BBCD where the user may be able to easily view the display element.

The housing 2800 may include various features that may provide access to controls and/or features of a mobile device housed therein. For instance, some embodiments may include a cutout to expose a headphone jack provided by the mobile device. As another example, some embodiments may include cutout or transparent sections to allow use of a camera included in the mobile device.

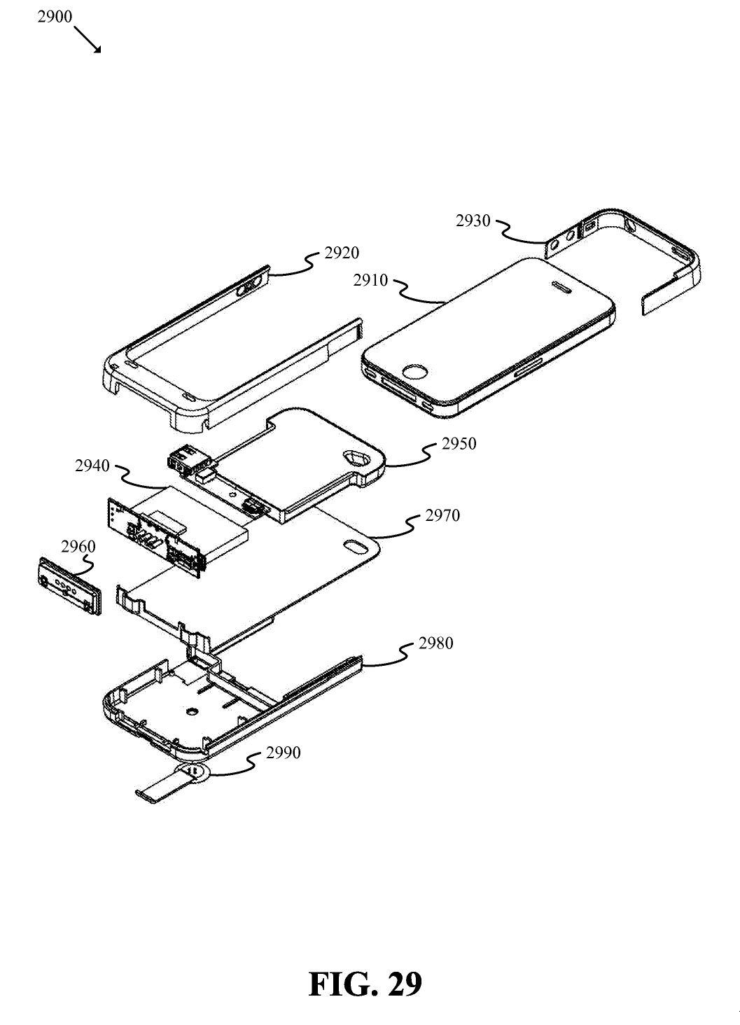

FIG. 29 illustrates an exploded view 2900 of a BBCD housing 2800 of some embodiments. As shown, the housing may store and protect a mobile device 2910, and the housing may include a bottom cover 2920, a top cover 2930, rear backing 2970, a rear cover 2980, and an attached stand 2990. The stand may be able to support the mobile device and housing in a vertical or horizontal configuration. BBCD electronics 2940 may include and/or connect to a charger 2850 which may have built-in AC prongs (not shown), internal battery, and/or any other appropriate components. The BBCD electronics 2940 may also include and/or connect to a display element 2960, which may have four display LEDs (and/or other appropriate indicators) accessible to the BBCD electronics 2940. The BBCD electronics, charger, battery and AC plug 2950 may be secured by a rear tray 2970, and a rear cover 2980.

D. Exemplary Housing for Removable Charger and Battery

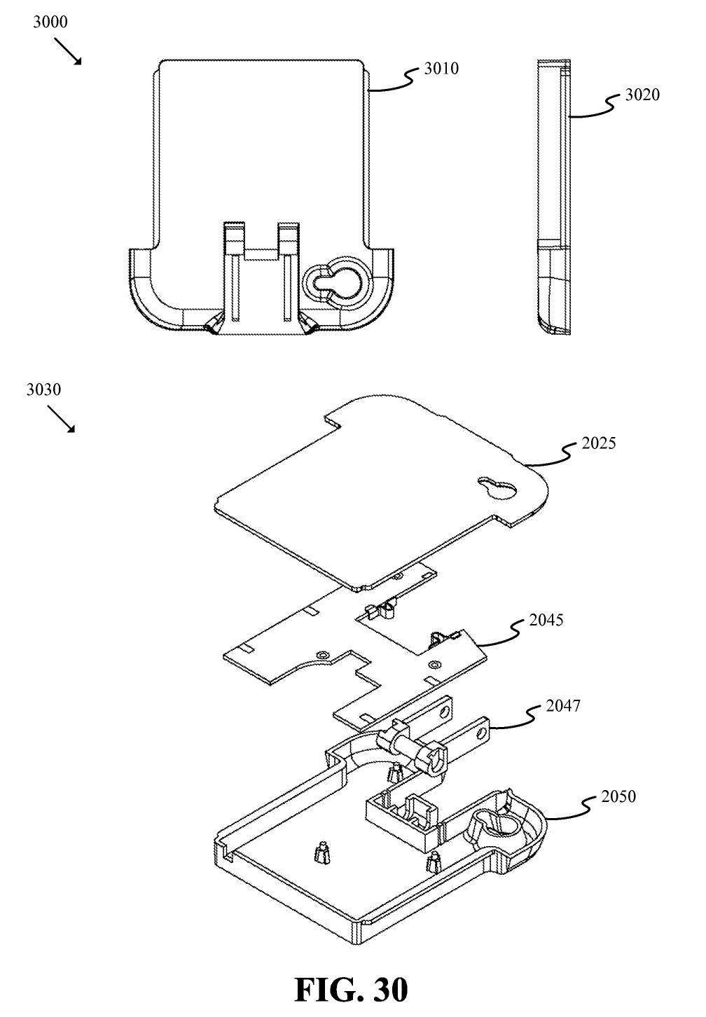

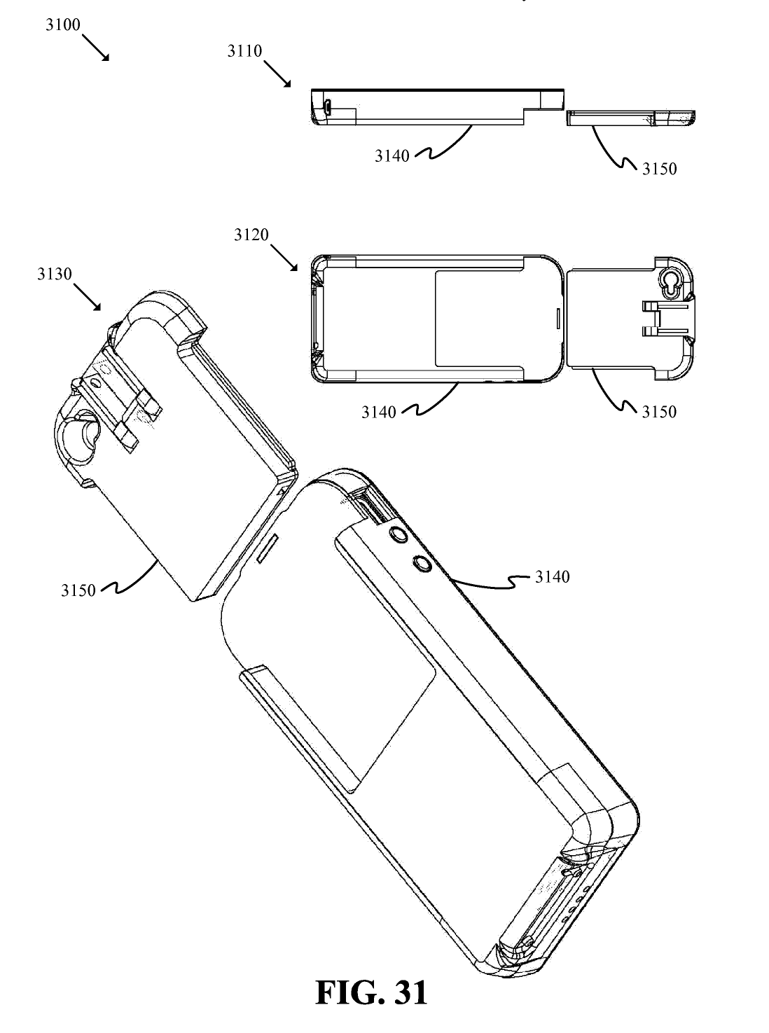

The following sub-section describes, with reference to FIGS. 30-31, an exemplary removable charger and battery housing of some embodiments. Such housing may be adapted to be used with a variety of devices and/or device manufacturers, as appropriate.

FIG. 30 illustrates several views of a removable charger 3000 of some embodiments. The charger is shown from a rear view 3010, a side view 3020, and an exploded view 3030. The exploded view shows the cover or backing element 2025, a PCB 2045, a set of AC prongs 2047 and removable charger housing 2050 of some embodiments.

FIG. 31 illustrates several views of a housing 3100 including a removable charger of some embodiments. The figure includes a side view 3110, a rear view 3120, and a perspective view 3130 of the BBCD of some embodiments of the present invention. As shown, the housing may include a main section 3140 and a removable section 3150. Such a removable section may be made to be universal (i.e., to fit various housings made by third parties). Any third party may be able to develop a main section 3140 of a housing that may then be able to connect to the removable section 3150 provided by some embodiments.

E. Exemplary Housing for Mobile Device Charger without Battery

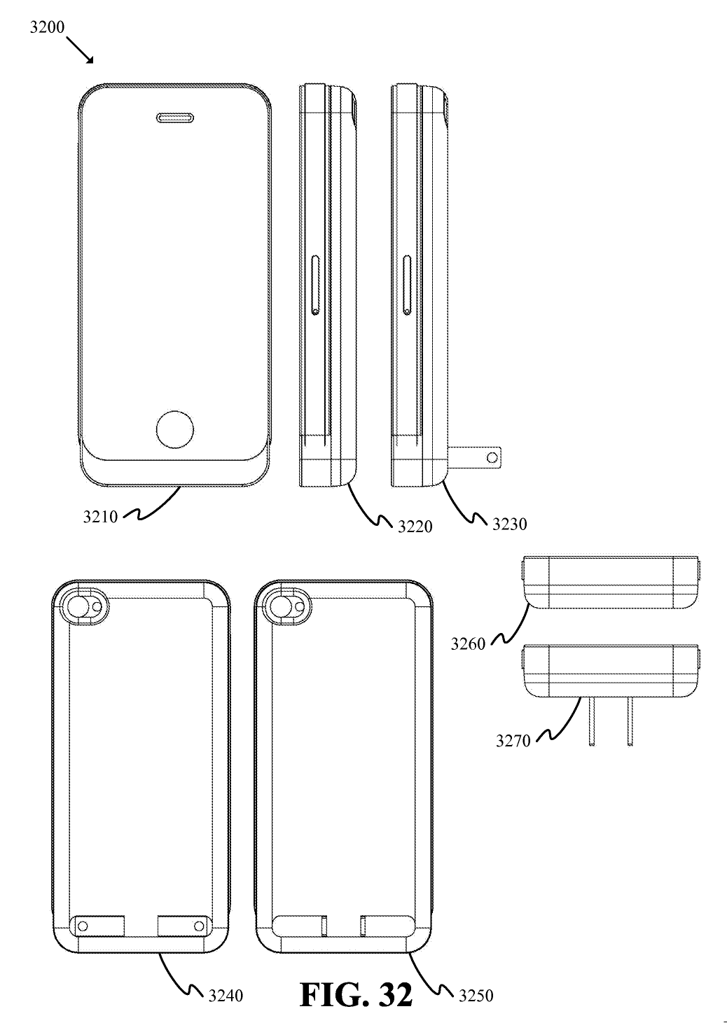

The following sub-section describes, with reference to FIG. 32, an exemplary mobile device charger of some embodiments.

FIG. 32 illustrates various views of an alternative, charger-only, housing 3200 of some embodiments. In this example, the housing may include a charger (and associated electronics) but not a battery. In this way, the charger-only version of the device may be able to have a slimmer profile than if a battery were included. As shown, the figure includes a front view 3210, a side view 3220 (with prongs refracted), a side view 3230 (with prongs extended), a back view 3240 (with prongs refracted), a rear view 3250 (with prongs extended), an end view 3260 (with prongs retracted), and an end view (with prongs extended) 3270.

By placing AC prongs near the end of the housing, the charger may be connected to a typical AC wall outlet such that only one of two available outlets is used.

F. Exemplary Housing for Computing Devices

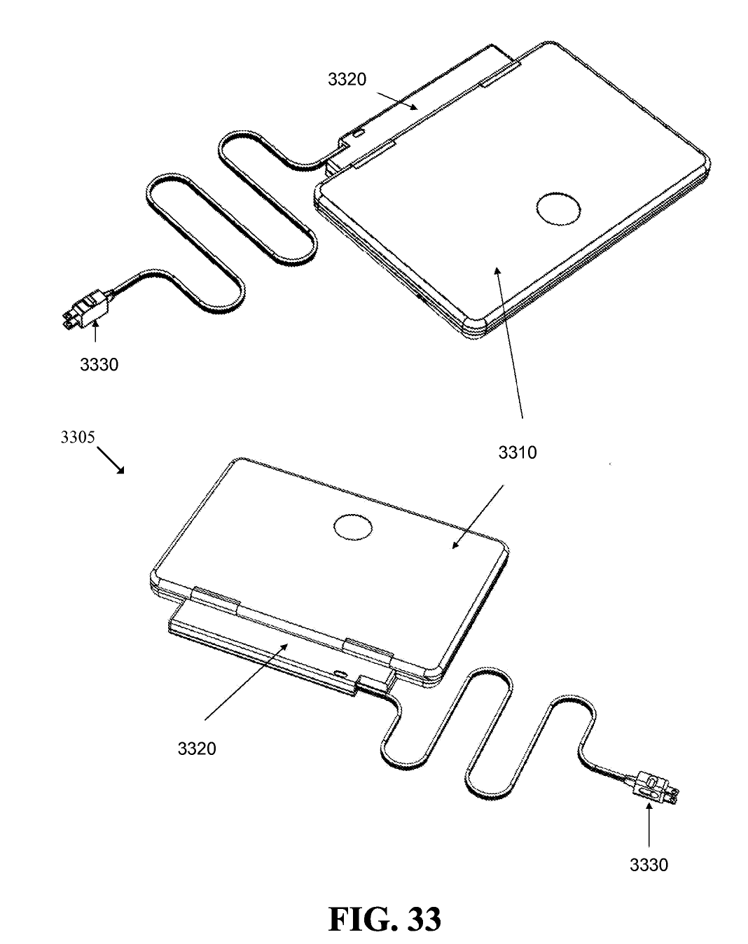

The following sub-section describes, with reference to FIGS. 33-37, an exemplary housing for computing devices of some embodiments. Such housing may be adapted to be used with a variety of devices and/or device manufacturers, as appropriate.

FIG. 33 illustrates two perspective views of an exemplary embodiment of a BBCD 3320 for a notebook computer 3310 (or other computing device, such as a tablet device) where the BBCD 3320 includes an AC plug 3330 with extendable cable. As shown, the BBCD 3320 may be incorporated as an extension to a power supply of the notebook computer 3310.

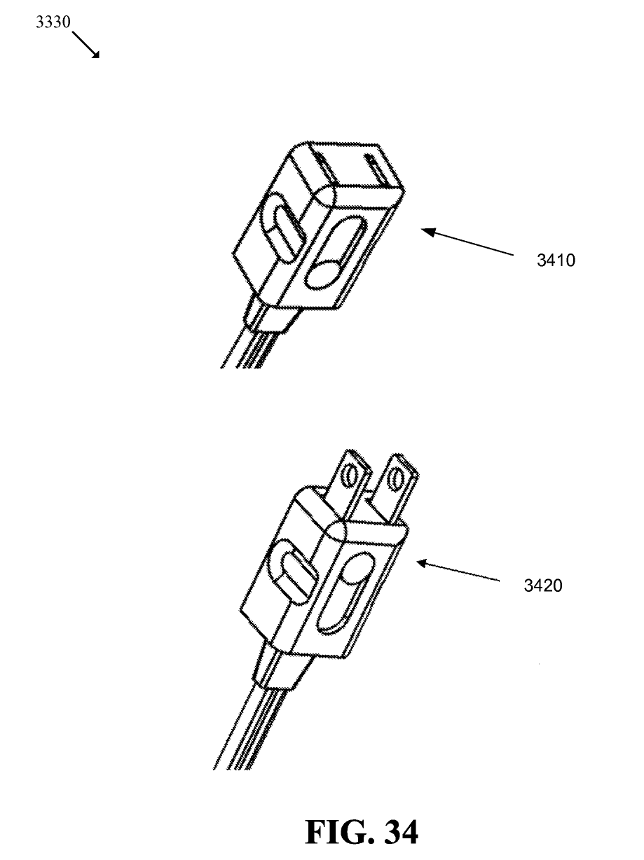

FIG. 34 illustrates one embodiment of a retractable AC plug 3330 that may be included in the BBCD of FIG. 33. Such a plug may be able to be stored in the BBCD housing when not in use. As shown, the AC plug may include retractable prongs. The prongs may be adapted to be able to be retracted into the AC plug in a first position 3410 for storage and/or when not in use. The prongs may be adapted to be extended out of the AC plug in a second position 3420 when in use. The retractable AC plug may have a slide, push button, switch, or any other appropriate way to retract the prongs of the AC plug so it may fit in a housing of the BBCD.

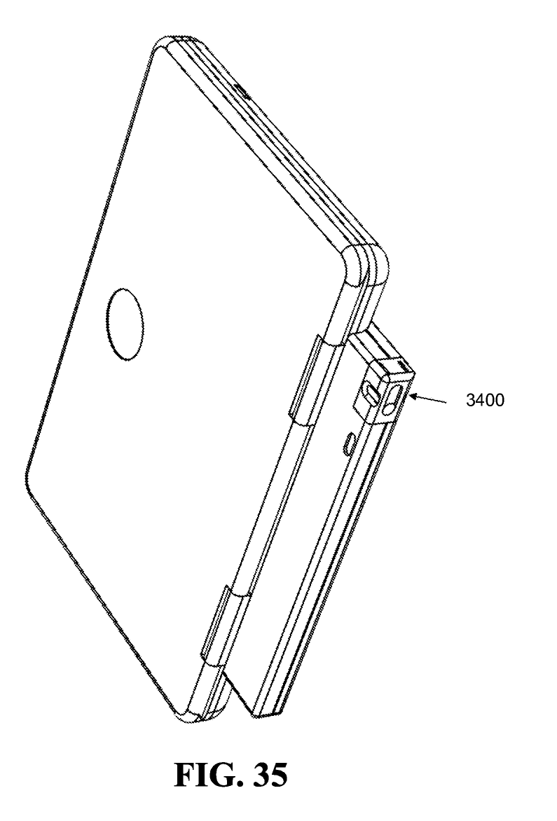

FIG. 35 illustrates the retractable AC plug 3330 of FIG. 34 with an attached cable wound up and retracted into the housing of the BBCD of FIG. 33. A similar retractable plug may also be provided in some embodiments of a BBCD for cellular phones. Retractable AC prong mechanisms for a cellular BBCD may use thinner DC wires in order to maintain a thin profile for the housing of the cellular phone BBCD.

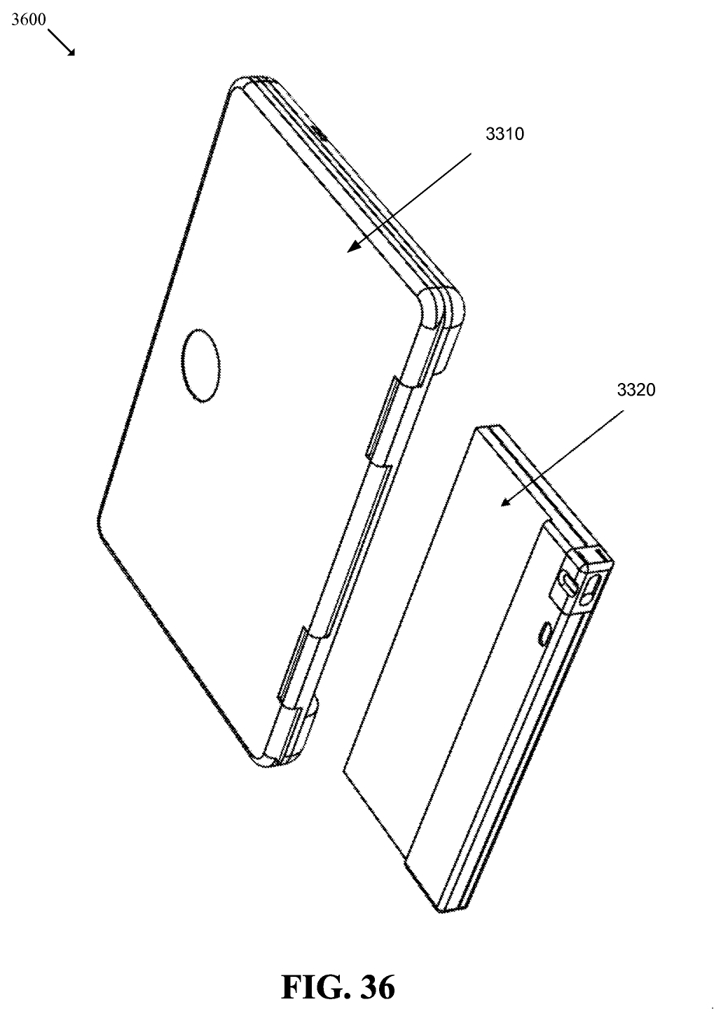

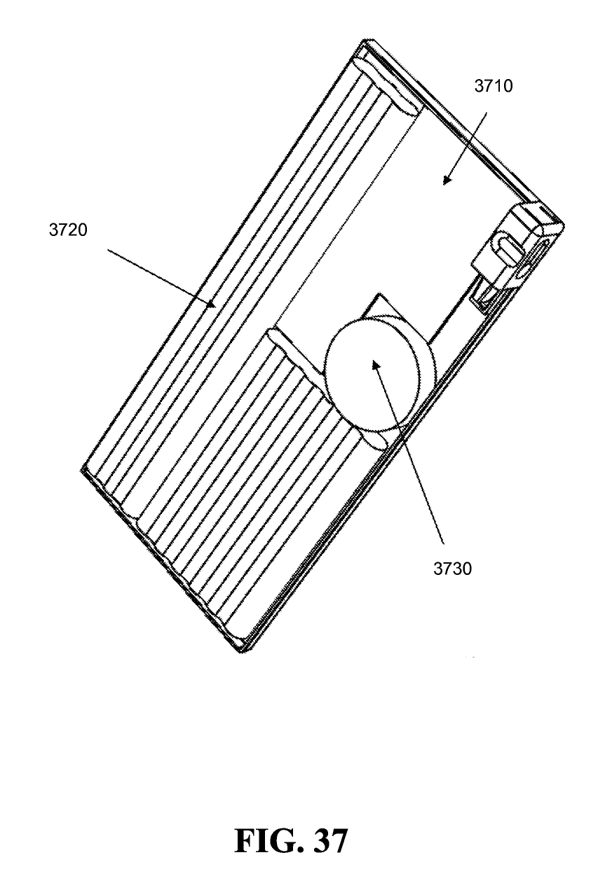

FIG. 36 illustrates the BBCD 3320 of FIG. 33 removed from the computing device 3310. FIG. 37 illustrates a bottom view of the BBCD of FIG. 33 showing a power supply 3710, battery cells 3720, and AC cord winder 3730.

G. Alternative Exemplary Housing for Computing Devices

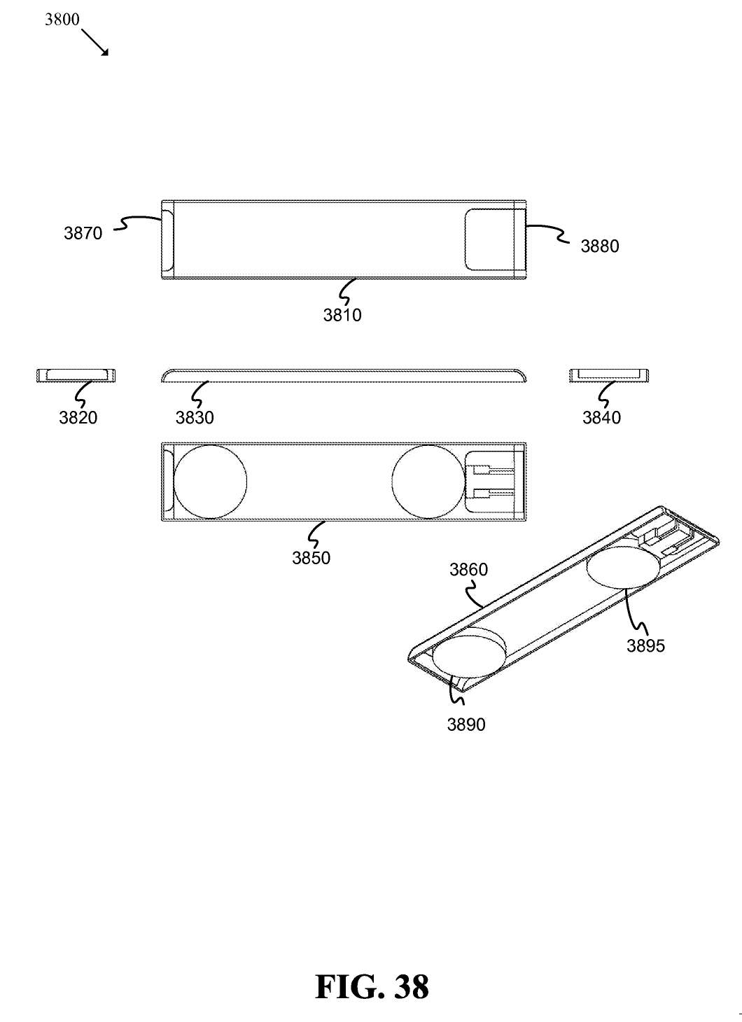

The following sub-section describes, with reference to FIG. 38, an alternative exemplary housing for computing devices of some embodiments. Such housing may be adapted to be used with a variety of devices and/or device manufacturers, as appropriate.

FIG. 38 illustrates several views of a BBCD housing 3800 that may be adapted to be used with various computing devices (e.g., tablet devices, notebook computers, etc.). As shown, the figure includes a top view 3810, left side view 3820, front view 3830, right side view 3840, bottom view 3850, and a perspective view 3860 of the BBCD housing 3800. The housing of some embodiments may be adapted to fit in a typical cover for the computing device. The top view 3810 shows a compartment 3870 for ear buds and a compartment 3880 for an AC plug and extendable/retractable cord. A perspective view also shows a winder for ear bud cables 3890 and a winder for the AC plug 3895 that may be able to automatically retract and extend the cables.

The various housings described above in reference to FIGS. 14-38 may be implemented using various appropriate materials (e.g., plastic, metal, rubber, composite materials, etc.) and/or combinations of materials. In addition, the housings may be implemented in various different ways without departing from the spirit of the invention. For instance, different housings may have different specific openings (e.g., for a camera lens of a device), different specific features (e.g., display elements, controls, etc.), different physical configurations (e.g., different types of attachment mechanisms, differently-shaped covers or other housing elements, etc.), and/or other differences, as appropriate. In addition, some embodiments of the housing may include rubber grips on the side of the housing to allow a user to be better able to handle the housing.

### V. Embedded Solutions

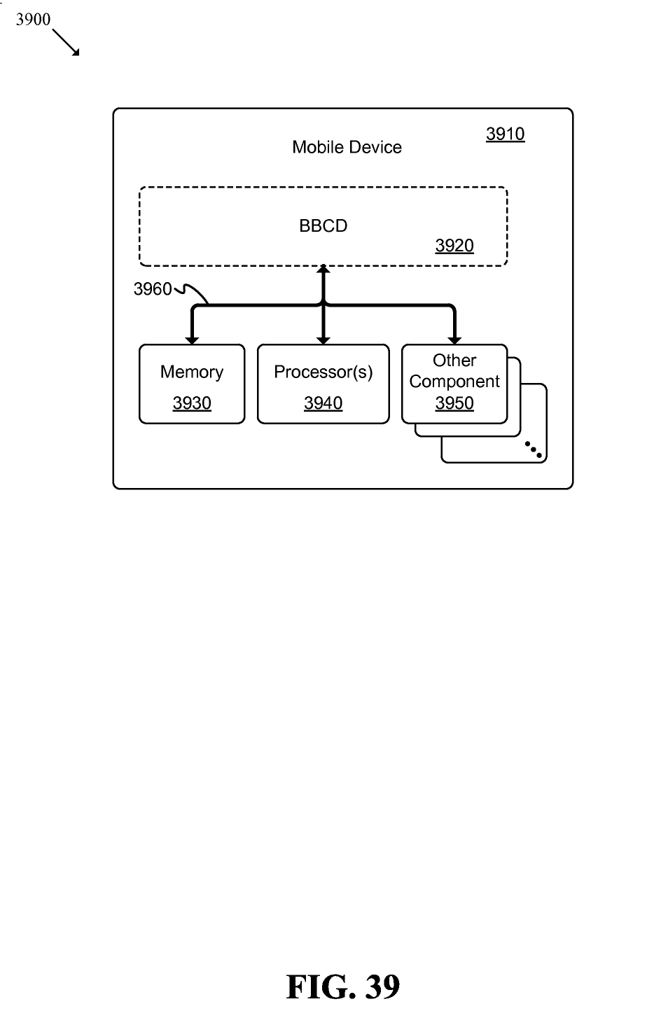

In addition to externally housed BBCDs, some users (and/or manufacturers) may wish to embed a BBCD in a mobile device. Various examples of such embedded solutions are described below in reference to FIG. 39. One of ordinary skill in the art will recognize that the examples of embedded solutions described below are for illustrative purposes only and that different embodiments may be implemented in various different ways in order to support various specific devices, as appropriate.

FIG. 39 illustrates a schematic block diagram of a device 3900 that includes an embedded BBCD of some embodiments. As shown, the device may include a mobile device 3910, a BBCD 3920, as well as memory 3930, one or more processors 3940, and/or other components 3950. Such elements may be connected to one or more communication busses 3960.

The mobile device 3910 may include any electronic device that may use battery power (e.g., a smartphone, a tablet, etc.). The BBCD 3920 may include similar components to the BBCDs described above in reference to FIGS. 7-9. The memory 3930 may include one or more memory elements capable of storing data and/or instructions. The processor 3940 may include one or more processing devices capable of executing instructions and processing data. The other components 3950 may include input/output devices (e.g., touchscreens, speakers, microphones, etc.), controls (e.g., pushbuttons, switches, etc.), and/or other appropriate components.

The embedded BBCD of some embodiments may allow a user to enjoy the benefits of the BBCD (increased battery life, ease of charging without external cables, etc.), without having to use an external housing. Instead, a mobile device manufacturer, for instance, may simply replace a back plate with a BBCD-embedded back plate. In this way, the mobile device may have a consistent external design and the slimmest possible profile.

### VI. Applications

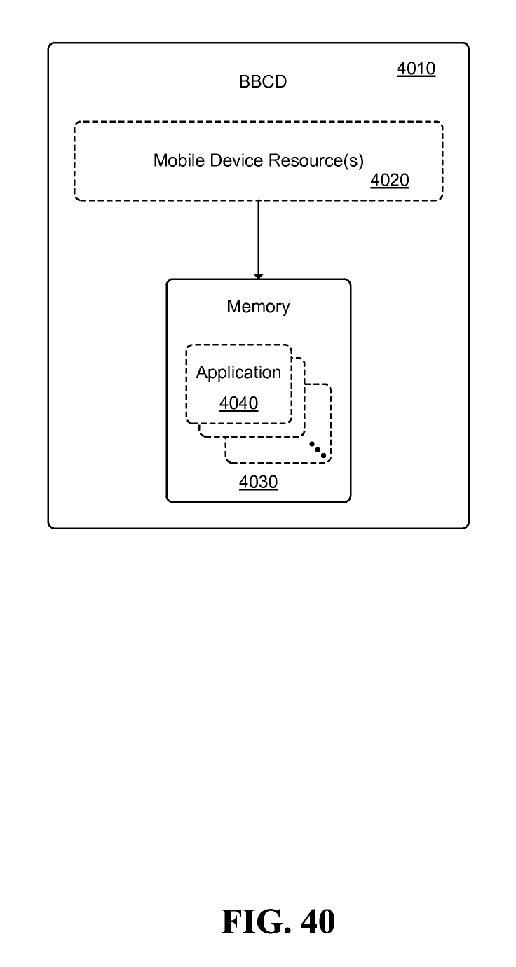

Some embodiments of the BBCD may be able to execute various applications. Such execution of applications is described below in reference to FIG. 40. One of ordinary skill in the art will recognize that the examples described below are for illustrative purposes only and that different embodiments may be implemented in various different ways in order to support various specific devices, as appropriate.

FIG. 40 illustrates a conceptual schematic block diagram of a BBCD 4010 of some embodiments. As shown, the BBCD may have access to one or more mobile device resources 4020 (e.g., a processor, memory, input/output devices, etc.), and may include a memory 4030 that may store one or more applications 4040. While connected to a mobile device, the BBCD 4010 may be able to use internal resources (e.g., memory 4030) and/or resources provided by the mobile device. The memory 4030 may include one or more memory elements capable of storing data and/or sets of instructions.

The applications 4040 may allow a user to utilize BBCD and/or mobile device resources to provide various features such as streaming video (e.g., television), audio (e.g., FM radio), camera, etc., which may be implemented using computer code. The applications 4040 may also allow a user to access video, audio, etc. independent of the mobile device while still using resources of the mobile device (e.g., speakers, video screen, etc.). Further, the applications 4040 may be able to implement advertising, pay services, and/or other external services, as appropriate.

### VII. Computer System

Many of the processes and modules described above may be implemented as software processes that are specified as at least one set of instructions recorded on a non-transitory storage medium. If these instructions are executed by one or more computational element(s) (e.g., microprocessors, microcontrollers, Digital Signal Processors (“DSP”), Application-Specific ICs (“ASIC”), Field Programmable Gate Arrays (“FPGA”), etc.) the instructions cause the computational element(s) to perform actions specified in the instructions.

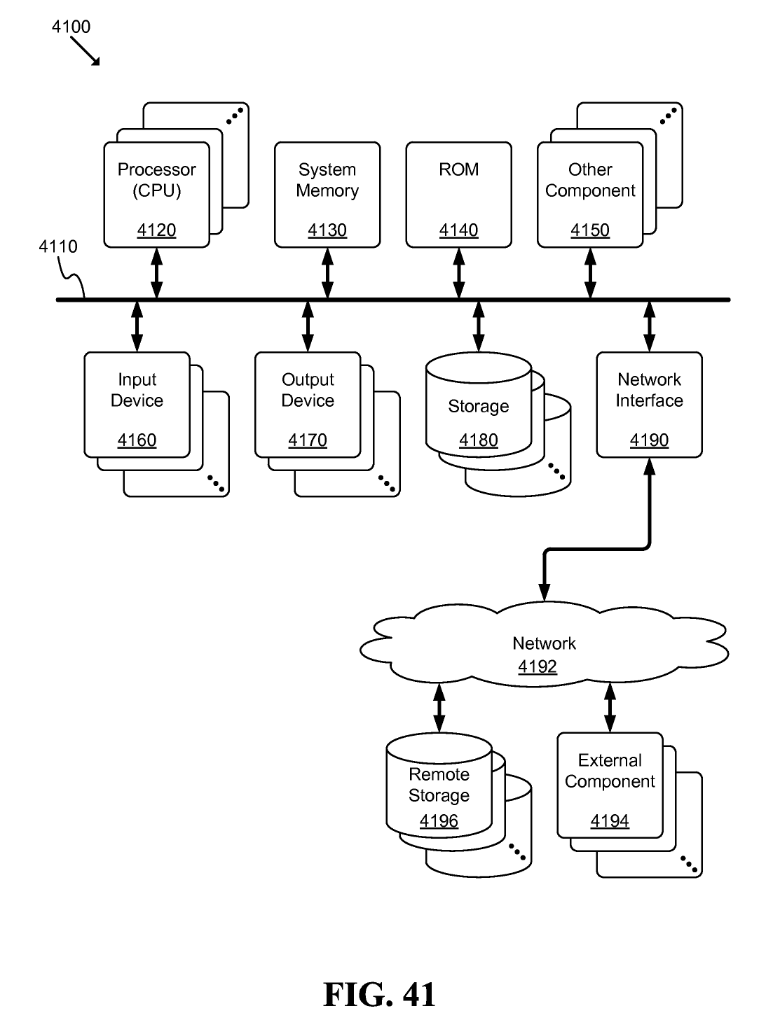

FIG. 41 conceptually illustrates a schematic block diagram of a computer system 4100 with which some embodiments of the invention may be implemented. For example, the system described above in reference to FIG. 1 may be at least partially implemented using computer system 4100. As another example, the processes described in reference to FIGS. 2 and 11-13 may be at least partially implemented using sets of instructions that are executed using computer system 4100.

Computer system 4100 may be implemented using various appropriate devices. For instance, the computer system may be implemented using one or more personal computers (“PC”), servers, mobile devices (e.g., a Smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

Computer system 4100 may include a bus 4110, at least one processing element 4120, a system memory 4130, a read-only memory (“ROM”) 4140, other components (e.g., a graphics processing unit) 4150, input devices 4160, output devices 4170, permanent storage devices 4180, and/or a network connection 4190. The components of computer system 4100 may be electronic devices that automatically perform operations based on digital and/or analog input signals.

Bus 4110 represents all communication pathways among the elements of computer system 4100. Such pathways may include wired, wireless, optical, and/or other appropriate communication pathways. For example, input devices 4160 and/or output devices 4170 may be coupled to the system 4100 using a wireless connection protocol or system. The processor 4120 may, in order to execute the processes of some embodiments, retrieve instructions to execute and data to process from components such as system memory 4130, ROM 4140, and permanent storage device 4180. Such instructions and data may be passed over bus 4110.

ROM 4140 may store static data and instructions that may be used by processor 4120 and/or other elements of the computer system. Permanent storage device 4180 may be a read-and-write memory device. This device may be a non-volatile memory unit that stores instructions and data even if computer system 4100 is off or unpowered. Permanent storage device 4180 may include a mass-storage device (such as a magnetic or optical disk and its corresponding disk drive).

Computer system 4100 may use a removable storage device and/or a remote storage device as the permanent storage device. System memory 4130 may be a volatile read-and-write memory, such as a random access memory (“RAM”). The system memory may store some of the instructions and data that the processor uses at runtime. The sets of instructions and/or data used to implement some embodiments may be stored in the system memory 4130, the permanent storage device 4180, and/or the read-only memory 4140. For example, the various memory units may include instructions for defining a charging scheme in accordance with some embodiments. Other components 4150 may perform various other functions.

Input devices 4160 may enable a user to communicate information to the computer system and/or manipulate various operations of the system. The input devices may include keyboards, cursor control devices, audio input devices and/or video input devices. Output devices 4170 may include printers, displays, and/or audio devices. Some or all of the input and/or output devices may be wirelessly or optically connected to the computer system.

Finally, as shown in FIG. 41, computer system 4100 may be coupled to a network 4192 through a network adapter 4190. For example, computer system 4100 may be coupled to a web server on the Internet such that a web browser executing on computer system 4100 may interact with the web server as a user interacts with an interface that operates in the web browser.

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 4100 may be used in conjunction with the invention. Moreover, one of ordinary skill in the art will appreciate that many other system configurations may also be used in conjunction with the invention or components of the invention.

Moreover, while the examples shown may illustrate many individual modules as separate elements, one of ordinary skill in the art would recognize that these modules may be combined into a single functional block or element. One of ordinary skill in the art would also recognize that a single module may be divided into multiple modules.

While the invention has been described with reference to numerous specific details, one of ordinary skill in the art will recognize that the invention can be embodied in other specific forms without departing from the spirit of the invention. For example, several embodiments were described above by reference to particular features and/or components. However, one of ordinary skill in the art will realize that other embodiments might be implemented with other types of features and components. One of ordinary skill in the art would understand that the invention is not to be limited by the foregoing illustrative details, but rather is to be defined by the appended claims.

I claim:

1. A housing for a mobile device, the housing comprising:
a battery;
a charger coupled to the battery;
AC prongs coupled to the charger; and
a connection module adapted to connect the battery and charger to the mobile device.

2. The housing of claim 1, wherein the charger comprises a planar transformer.

3. The housing of claim 1, wherein the connection module comprises a communication port for connection to at least one external device.

4. The housing of claim 3, wherein the communication port is a universal serial bus (USB) port.

5. The housing of claim 1 further comprising a boost converter coupled to the battery and adapted to provide a charging output to an internal battery of the mobile device.

6. The housing of claim 1, wherein the charger is adapted to provide a charging current to at least one of the battery and an internal battery of the mobile device.

7. The housing of claim 1 further comprising a set of indication LEDs adapted to provide a visual status of the charge level of the battery.

8. The housing of claim 1 further comprising:
an extendable cable coupled to the AC prongs; and
a winder adapted to store any unused portion of the extendable cable.

9. The housing of claim 1, wherein the mobile device is one of a smartphone, a tablet device, and a notebook computer.

10. A system adapted to provide charging and backup battery power, the system comprising:
an AC power source;
a backup battery and charging device (BBCD) coupled to the AC power source, the BBCD comprising:
a backup battery;
a charger coupled to the backup battery; and
AC prongs coupled to the charger, the AC prongs adapted to couple to the AC power source; and
a mobile device coupled to the BBCD, the mobile device comprising a battery.

11. The system of claim 10, wherein the mobile device and the BBCD are enclosed in a single housing.

12. The system of claim 10, wherein the charger is adapted to provide charge to at least one of the backup battery and the mobile device battery.

13. The system of claim 12, wherein the charger is adapted to provide charge to the backup battery and the mobile device battery in parallel.

14. The system of claim 10, wherein the charger comprises a planar transformer.

15. The system of claim 10, wherein the mobile device is one of a smartphone, a tablet device, and a notebook computer.

16. The system of claim 10, wherein the BBCD further comprises a retractable cord coupled between the charger and the AC prongs.

17. The system of claim 10, wherein the BBCD further comprises a boost converter coupled to the battery and adapted to provide a charging output to an internal battery of the mobile device.

18. The system of claim 10, wherein the BBCD further comprises a communication port for connection to at least one external device.

19. A mobile device with an embedded battery backup and charging device (BBCD), the mobile device comprising:
a primary battery;
a backup battery coupled to the primary battery;
a charger coupled to the battery; and
AC prongs coupled to the charger.

20. The mobile device of claim 19, wherein the charger comprises a planar transformer.
